(19) United States
(12) Patent Application Publication
(10) Pub. No.: US 2025/0333871 A1
(43) Pub. Date: Oct. 30, 2025

(54) ELECTRODEPOSITION OF NANOTWINNED CU ALLOYS

(71) Applicant: Apple Inc., Cupertino, CA (US)

(72) Inventor: Herng-Jeng Jou, Lake Stevens, WA (US)

(21) Appl. No.: 19/096,878

(22) Filed: Apr. 1, 2025

Related U.S. Application Data
(60) Provisional application No. 63/638,342, filed on Apr. 24, 2024.

(51) Int. Cl. C25D 3/58; C22C 9/06

(52) U.S. Cl. CPC C25D 3/58; C22C 9/06

(57) ABSTRACT

An alloy includes an electrodeposited first metal and a second metal, the alloy material having crystal grains. At least 75% of the crystal grains comprise nanotwin boundaries. The first metal includes copper, and the second metal includes a metal includes at least one of cobalt (Co), iron (Fe), or Palladium (Pd).

### CROSS-REFERENCE TO RELATED APPLICATIONS

This application claims the benefit of U.S. Provisional Application No. 63/638,342, filed 24 Apr. 2024, entitled “ELECTRODEPOSITION OF NANOTWINNED CU ALLOYS,” the entire disclosure of which is hereby incorporated by reference.

### FIELD

The described embodiments relate generally to electronic device components. More particularly, the present embodiments relate to electronic components including nanotwinned metals.

### BACKGROUND

Recent technological advances have enabled manufactures to include a large number of operational components, such as processors, antennas, displays, cameras, haptic feedback components, and batteries, in a relatively small internal volume defined by a housing or enclosure of a portable electronic device. Due to the drive for thinner and smaller electronic devices, the internal volume of the various devices can be relatively small and can include a number of operational components in close proximity with one another. Further, the increasing performance levels of these components can require greater amounts of power to be delivered to the components in shorter amounts of time.

In use, the levels of electrical resistance and thermal conductivity in these operational components, and in circuits including these operational components, can result in the generation of heat or thermal energy that results in elevated operating temperatures. Traditionally, metal alloys have been included in the materials forming operational components and circuits to reduce the electrical resistance. This approach can result in materials that have a relatively low resistance, but that also have a relatively low mechanical strength. Similarly, techniques to increase the mechanical properties of the materials of operational components and circuits can result in materials that have a relatively high electrical resistance. Accordingly, it can be desirable to provide materials that have desired levels of electrical resistance and thermal conductivity, while also achieving desired mechanical properties.

### SUMMARY

According to some aspects of the present disclosure, an alloy material can include an electrodeposited first metal and a second metal. In one example, the alloy material can include crystal grains. In one example, at least 75% of the crystal grains can include nanotwin boundaries. In some examples, the crystal grains can have an average grain size between about 190 and 940 nanometers (nm). In some examples, the first metal includes copper. The second metal can include a metal that includes at least one of cobalt (Co), iron (Fe), or Palladium (Pd). The alloy material can have a thickness of less than 50 microns.

In at least some examples, the alloy material can exhibit a tensile strength greater than about 750 MPa. In some examples, the crystal grains can have an average spacing between nanotwin boundaries of less than 120 nanometers (nm). In some examples, at least 85% of the crystal grains can include nanotwin boundaries. In one example, the alloy material can exhibit a tensile elongation greater than 2.5%.

In another example of the present disclosure, an electronic device can include a conductive component that includes an alloy material having crystal grains, the alloy material including a copper (Cu) alloy having a thickness of greater than 20 microns and at least 70% of the crystal grains including nanotwin boundaries. In one example, the copper alloy can include less than about 40 ppm cobalt (Co), iron (Fe), or Palladium (Pd). In one example, the conductive component is an electrically conductive component. In at least one example, the electrically conductive component can include a charging receptacle. In another example, the electrically conductive component can include an electrical connector between two electronic components. In some examples, the electrically conductive component can include a battery. In at least one example, the conductive component can be a thermally conductive component. In one example, the thermally conductive component can include a support plate.

In one example, the present disclosure includes a method of forming a component that includes electroplating a metallic material including crystal grains, where one or more of the crystal grains includes nanotwin boundaries. In some examples, the metallic material can include a copper (Cu) alloy that includes less than about 40 ppm cobalt (Co), iron (Fe), or Palladium (Pd).

In some examples, electroplating a metallic material can include at least partially immersing the carrier in an electrolyte solution including cations of the metallic material and a suppressor agent. In some examples, the electrolyte solution can exhibit a temperature between about 17° C. and about 25° C. In at least one example, depositing the metallic material can include co-electroplating the carrier with ions of copper (Cu) and ions selected from the group consisting of cobalt (Co), iron (Fe), or Palladium (Pd).

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a plot of thermal conductivity versus tensile strength and elongation for various alloy materials.

FIG. 2A shows a scanning electron micrograph of a cross-section of a nanotwinned Cu material.

FIG. 2B shows a scanning electron micrograph of a cross-section of a nanotwinned Cu—Co alloy material at 0.1M concentration Co.

FIG. 2C shows a scanning electron micrograph of a cross-section of a nanotwinned Cu—Co alloy material at 0.5M concentration Co.

FIG. 2D shows a scanning electron micrograph of a cross-section of a nanotwinned Cu—Co alloy material at 0.1M concentration Co and 17° C. electrolyte temperature.

FIG. 3A shows a scanning electron micrograph of a cross-section of a nanotwinned Cu material.

FIG. 3B shows a scanning electron micrograph of a cross-section of a nanotwinned Cu—Fe alloy material at 0.05M concentration Fe.

FIG. 3C shows a scanning electron micrograph of a cross-section of a nanotwinned Cu—Co alloy material at 0.1M concentration Fe.

FIG. 3D shows a scanning electron micrograph of a cross-section of a nanotwinned Cu—Co alloy material at 0.25M concentration Fe.

FIG. 3E shows a graph of Linear Sweep Voltammetry (LSV) results for Cu—Fe alloy materials at various concentrations of Fe.

FIG. 4A shows a scanning electron micrograph of a cross-section of a nanotwinned Cu material.

FIG. 4B shows a scanning electron micrograph of a cross-section of a nanotwinned Cu—Pd alloy material.

FIG. 5 shows an electroplating system for forming a nanotwinned alloy material.

FIG. 6A shows a schematic diagram of a system for forming a nanotwinned metallic alloy material.

FIG. 6B shows a process flow diagram for a process of forming a nanotwinned metallic alloy material.

FIG. 7A shows a schematic diagram of a system for forming a nanotwinned metallic alloy material.

FIG. 7B shows a process flow diagram for a process of forming a nanotwinned metallic alloy material.

FIG. 8A shows a perspective view of an electronic device.

FIG. 8B shows an exploded view of the electronic device of FIG. 8A.

FIG. 9A shows a perspective view of electrical connectors of an electronic device.

FIG. 9B shows a perspective view of the electrical connectors of FIG. 9A arranged prior to being connected.

FIG. 9C shows a cross-sectional view of the electrical connectors of FIG. 9A in a connected arrangement.

FIG. 10A shows a perspective view of an electrical component of an electronic device.

FIG. 10B shows a cross-sectional view of the electrical component of FIG. 10A arranged to receive another electrical component.

FIG. 10C shows a cross-sectional view of the electrical component of FIG. 10A receiving another electrical component.

FIG. 11 shows a perspective view of an electronic component.

FIG. 12A shows a cross-sectional view of an electronic device.

FIG. 12B shows a close-up cross-sectional view of the electronic device of FIG. 12A.

FIG. 13 shows a component of an electronic device.

FIG. 14A shows a perspective view of a component of an electronic device.

FIG. 14B shows another perspective view of the component of FIG. 14A.

FIG. 15A shows a perspective view of an electronic device.

FIG. 15B shows a perspective view of a component of the electronic device of FIG. 15A.

FIG. 16A shows a perspective view of an electronic device and accessory component.

FIG. 16B shows a side view of the electronic device and accessory component of FIG. 16A.

FIG. 16C shows a cross-sectional view of the accessory component of FIG. 16A.

FIG. 17A shows a perspective view of a battery.

FIG. 17B shows a cross-sectional view of the battery of FIG. 17A.

FIG. 17C shows a schematic diagram of a portion of the battery of FIG. 17A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Typically, in electronic components that demand high levels of electrical and thermal conductivity, pure metallic materials having naturally high bulk electrical and thermal conductivities, such as copper or cobalt, can be used. In some applications, however, it can also be desirable for these high conductivity materials to have high levels of other material properties, such as a high strength that can allow the materials to provide mechanical support or have other functionalities in an electronic component or device.

For example, pure copper has an extremely high thermal conductivity and electrical conductivity, thereby allowing for the highly efficient transmission of heat, power, or signals through the material. The yield strength of copper, however, is relatively low and it can be difficult to achieve desired levels of mechanical strength in components including pure copper. Alloying elements within copper can increase strength but generally reduce the thermal and electrical conductivity of the copper material. Thus, depending on the use case of the material, a balance must be struck between the amount and type of alloying elements added to pure copper to obtain sufficient thermal and electrical conductivity as well as material hardness and yield strength for a specific application.

In addition to utilizing alloying elements within copper or other conductive metals, it can be desirable to use a material in electronic components that has a crystal structure with features that impede the movement of dislocations, but that do not impede the flow of electrons. One such feature is known as a twin boundary. A twin boundary occurs when two crystals, for example, two regions of a crystal grain of a metallic material, share the same crystal lattice points in a symmetrical, but non-identical manner. These twin boundaries can impede dislocation movement, resulting in increased material strength, but because the same crystal lattice points are shared along the boundary, the twin boundary has essentially no effect on the conduction of thermal or electrical energy across the boundary. Typically, metallic materials do not include a high percentage of twin boundaries. In some examples, however, and as described herein, alloy metallic materials can be formed that include a high percentage of twin boundaries, with a large number of the crystal grains of the material including multiple twin boundaries, and with the boundaries themselves being separated by distances on the order of tens or hundreds of nanometers (nm). These materials can be referred to as nanotwinned materials, nanotwinned metals, and/or nanotwinned alloys, while the boundaries themselves, when separated by distances on the order of nanometers, can be referred to as nanotwin boundaries.

In the examples of materials described herein, it can be advantageous to combine the added material strength and hardness advantages of alloying elements with the nanotwin boundaries described above, which promote strength and hardness with minimal loss to the thermal and electrical conductivity of the material. Such materials, referred to herein as “nanotwinned alloy materials,” can allow for new component and device designs that take advantage of these improved material properties.

In some examples, a nanotwinned alloy material can include crystal grains, and at least 70% of the crystal grains can have nanotwin boundaries therein. The alloy material can include a copper (Cu) alloy as the first metal and the second metal selected from the group consisting of cobalt (Co), iron (Fe), or Palladium (Pd). The nanotwin boundaries can be spaced apart from one another within the crystal grains by between about 20 nanometers (nm) and about 120 nm. According to some examples, a battery can include multiple lithium-ion electrochemical cells that each have an anode, a cathode, a separator, and an electrolyte. Conductive current collectors can be electrically coupled to the anode and the cathode of each cell. A nanotwinned alloy material, such as a nanotwinned copper-based foil having a thickness greater than about 3 microns, can serve as the current collectors, and the active materials of the anode and/or cathode can be deposited onto the nanotwinned foil to form the anode and/or cathode.

The manufacture of large amounts or volumes of nanotwinned metallic alloy materials, such as nanotwinned Cu alloys, for example, in rolls having thicknesses of greater than 3 μm, can allow for nanotwinned metallic alloy materials to replace existing metallic materials and alloys in component and device manufacturing processes without the need for significant or costly modifications. In some examples, and as described herein, nanotwinned metallic alloy materials can be electrodeposited or electroformed in a desired shape and to a desired thickness, for example, greater than about 3 microns and up to several millimeters. In some examples, foils or films of nanotwinned metallic alloy materials can be formed by reel to reel or conductive barrel electrodeposition processes. Further, electroforming nanotwinned Cu alloys allows for formation of complex parts that can have well-defined edges and features, but that can be formed into shapes that would otherwise require techniques such as deep drawing to produce. Such deep drawing techniques typically result in less well-defined edges and features and increasing post-processing costs or reducing component performance.

The improved material properties, such as strength, hardness, electrical conductivity, and thermal conductivity of nanotwinned metallic alloy materials relative to non-nanotwinned and/or non-alloyed metallic materials can also allow for new component and device designs that take advantage of these improved material properties. For example, components that conduct or transmit electrical power can have smaller dimensions because the mechanical strength of the metallic portions of these components may no longer constrain the design. Further, the high levels of electrical conductivity provided by nanotwinned metallic alloy materials can allow for highly efficient power or signal transmission, even though these components having reduced dimensions. For example, the use of highly conductive nanotwinned metallic alloy materials in multiple components or locations along an electronic device's charging pathway can result in compounding efficiencies that allow for reduced charging times, increased battery life, and other advantages, as described herein.

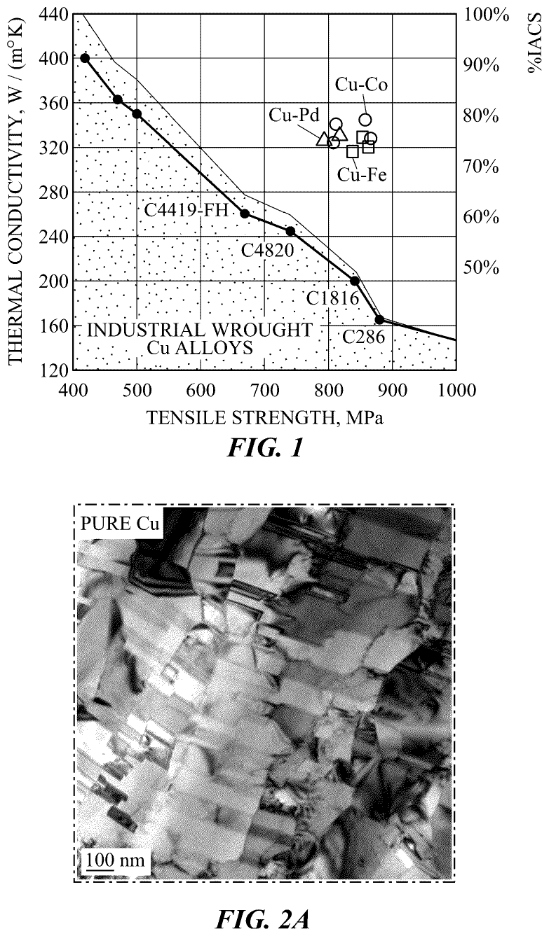

These and other embodiments are discussed below with reference to FIGS. 1-17C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a plot of thermal conductivity versus tensile strength for various alloy materials. Three important design properties for materials that form components of electronic devices, especially those components which require or transmit power or signals, are tensile strength, thermal conductivity, and electrical conductivity. As can be seen in FIG. 1, a material's tensile strength typically correlates with its hardness. A material's thermal conductivity also typically correlates with its electrical conductivity. Without being bound by any one theory, this can be because similar physical mechanisms are responsible for the thermal and electrical conductivity of a material. While it is desirable for the materials forming electronic components to have high thermal and electrical conductivities and high tensile strengths, as can be seen in FIG. 1, the thermal and electrical conductivity of a material tends to decrease as the hardness or yield strength of the material increases.

FIG. 1 shows the thermal conductivity, electrical conductivity, and tensile strength for three alloy materials. The alloy materials include a first metal, and a second metal electrodeposited onto the first metal. In each of the shown alloys, copper (Cu) is the first metal, and the second metal can include a metal selected from the group consisting of cobalt (Co), iron (Fe), or Palladium (Pd). In other words, FIG. 1 compares the properties of some industrial wrought Cu alloys with electrodeposited copper-cobalt (Cu—Co), copper-iron (Cu—Fe) and copper-palladium (Cu—Pd) alloy materials formed under various conditions.

As can be seen, the nanotwinned alloys have levels of thermal and electrical conductivity that are better than the industrial wrought copper alloys, while also exhibiting a hardness and tensile strength that is significantly higher and is equivalent to alloyed materials that have much lower electrical and thermal conductivities. This desirable combination of material properties can allow for components that are highly efficient at providing or transmitting thermal or electrical power or signals, and that can also be designed to carry or withstand relatively large mechanical loads, support other components, or otherwise serve structural functions. The combination of high strength and high conductivity means that relatively smaller amounts of nanotwinned metal alloys, such as the nanotwinned Cu-based alloys described herein, can be used to achieve desired levels of conductivity, while ensuring that this reduced amount of material or component size does not result in a component that is too weak to withstand the rigors of typical use.

In some examples, nanotwinned Cu-based alloys, as described herein, can have a yield strength of greater than about 750 megapascals (MPa). In some examples, nanotwinned Cu—Co, Cu—Fe, and/or Cu—Pd alloys can exhibit a tensile strength between about 750 MPa and about 1500 MPa. For example, nanotwinned Cu—Co, Cu—Fe, and/or Cu—Pd alloys can have a tensile strength of greater than about 900 MPa, greater than about 1000 MPa, greater than about 1100 MPa, greater than about 1200 MPa, greater than about 1300 MPa, greater than about 1400 MPa, or greater than about 1500 MPa, or more.

In some examples, nanotwinned Cu-based alloys, including nanotwinned Cu—Co, Cu—Fe, and/or Cu—Pd alloys as described herein, can have a Vickers Pyramid Number (Hv) or hardness of greater than about 330. In some examples, nanotwinned Cu-based alloys can have a hardness between about 330 Hv and about 625 Hv. For example, nanotwinned Cu-based alloys can have a yield strength of greater than about 330 Hv, greater than about 400 Hv, greater than about 450 Hv, greater than about 500 Hv, greater than about 550 Hv, greater than about 600 Hv, or greater than about 625 Hv, or more.

In some examples, nanotwinned Cu-based alloys, including nanotwinned Cu—Co, Cu—Fe, and/or Cu—Pd alloys as described herein, can have an electrical conductivity of greater than about 30% of the International Annealed Copper Standard value (% IACS). In some examples, nanotwinned Cu-based alloys can have an electrical conductivity of between about 30% IACS and about 85% IACS. For example, nanotwinned Cu—Co alloys can have an electrical conductivity of greater than about 30% IACS, greater than about 40% IACS, greater than about 50% IACS, greater than about 60% IACS, greater than about 70% IACS, greater than about 80% IACS, greater than about 85% IACS, or greater than about 90% IACS, or more.

In some examples, nanotwinned Cu-based alloys, including nanotwinned Cu—Co, Cu—Fe, and/or Cu—Pd alloys as described herein, can have a thermal conductivity of greater than about 120 watts per meter-kelvin (W/m·K). In some examples, nanotwinned Cu-based alloys can have a thermal conductivity of between about 120 W/m·K and about 360 W/m·K. For example, nanotwinned Cu-based alloys can have a thermal conductivity of greater than about 120 W/m·K, greater than about 160 W/m·K, greater than about 200 W/m·K, greater than about 240 W/m·K, greater than about 280 W/m·K, greater than about 320 W/m·K, or greater than about 360 W/m·K, or more.

In some examples, nanotwinned Cu-based alloys, including nanotwinned Cu—Co, Cu—Fe, and/or Cu—Pd alloys as described herein, can have crystal grains. The crystal grains can exhibit an average grain size of between 0.05 microns and 5 microns, between 0.1 microns and 1 micron, between 0.5 microns and 1.5 microns, between 0.2 microns and 0.8 microns, between 0.8 microns and 1.2 microns, between 0.3 microns and 0.7 microns, or between 0.4 microns and 0.6 microns, for example about 0.5 microns.

In some examples, nanotwinned Cu-based alloys, including nanotwinned Cu—Co, Cu—Fe, and/or Cu—Pd alloys as described herein, can have an elongation of between 0.1% and 10%, between 0.5% and 5%, or between 1% and 4%, for example about 2% or about 3%. In some examples, however, nanotwinned Cu-based alloys, as described herein, can have an elongation of greater than 10%, for example about 12%, 15%, 17%, or greater.

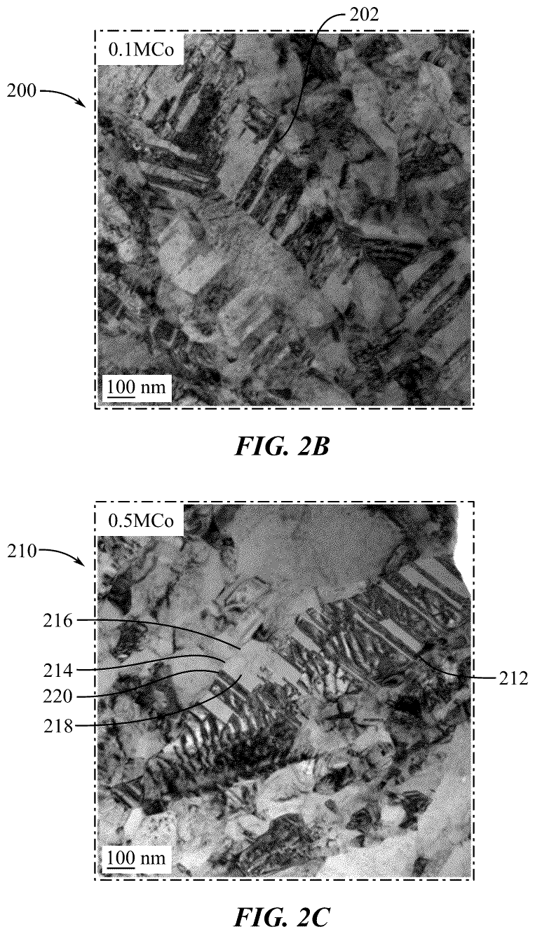

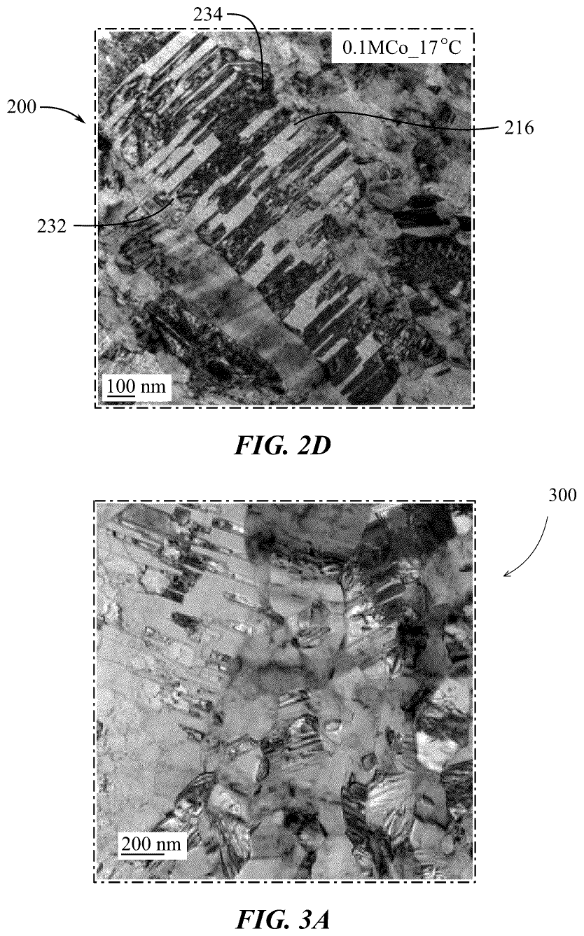

In general, nanotwinned metallic alloys, such as nanotwinned Cu-based alloys described herein, can be used to create nano-twinned alloy materials having improved strength while only minimally affecting conductivity, as discussed above. To illustrate nano-twinned alloy material characteristics in general, FIGS. 2A-2D illustrate nanotwin structures of a Cu—Co alloy substrate.

FIG. 2A shows a transmission electron micrograph of a cross-section of nanotwinned pure copper (Cu) material. The material includes crystal grains, which can be seen in FIG. 2A. The pure copper material columnar grains can include nanotwin boundaries. In some examples, substantially all or 100% of the crystal grains of a metallic material can include multiple nanotwins. In some examples, greater than 50%, greater than 60%, greater than 70%, greater than 75%, greater than 80%, greater than 85%, greater than 90%, greater than 91%, greater than 92%, greater than 93%, greater than 94%, greater than 95%, greater than 96%, greater than 97%, greater than 98%, or greater than 99%, or more of the crystal grains of a metallic material can include multiple nanotwins.

FIG. 2B shows a transmission electron micrograph of a cross-section of a nanotwinned Cu—Co alloy material 200 at 0.1M concentration Co. The nanotwinned Cu—Co alloy 200 is made up of a number of crystal grains 202. The cobalt refines the grain sizes, which enhances strength of the material. In some examples, the crystal grains including a metallic material that can be relatively uniform in size, or can vary from small to large, depending on how the material was formed and/or treated. In some examples, nanotwinned Cu—Co alloys, as described herein, can have an average grain size of between 0.2 microns and 0.5 microns, between 0.2 microns and 0.4 microns, between 0.2 microns and 0.3 microns. For example, the nanotwinned Cu—Co alloys can have an average grain size of about 0.50 microns.

The crystal grain 202 can be seen to have a regular repeating striped pattern, which is due to the presence of repeating twin boundaries, or nanotwins, as described herein. In at least one example, crystal grains 202 can be columnar grains that are about 900 nm wide, or between about 900-1 μm wide, for example between about 920-960 nm wide. In one example, the inclusion of cobalt to form the Cu—Co alloy material disrupts the crystal orientation of the grains, which increases ductility.

FIG. 2C shows a scanning electron micrograph of a cross-section of a nanotwinned Cu—Co alloy material 210 at 0.5M concentration Co. Increasing the Co2+ ion concentration can act to refine the microstructure and increase strength of the alloy, without impacting the electrical conductivity. Further, the increased Co2+ ion concentration reduces the overall grain size. In some examples, the Co2+ ion concentration can form smaller columnar grains and can reduce twin spacing. In other words, the micrograph of FIG. 2C shows a first crystal grain 212 and a second, adjacent crystal grain 214. The crystal grain 212 includes a number of twin boundaries that are spaced apart from one another by between about 2-5 nm. In some examples, the crystal grains of a nanotwinned metal alloy, such as nanotwinned Cu—Co alloy material 210 described herein, can include twin boundaries spaced apart from one another by less than about 200 nm, less than about 150 nm, less than about 100 nm, less than about 75 nm, less than about 50 nm, less than about 25 nm, less than about 20 nm, less than about 15 nm, less than about 10 nm, less than about 5 nm, or less than about 2 nm or smaller.

For example, the crystal grain 212 includes a twin boundary 216 between a first region 218 of the crystal grain having a first crystal lattice arrangement, here shown in light gray, and a second region 220 of the crystal grain that shares the same lattice points with the first region 218 along the boundary 216. The second region 220, however, has a second, symmetrical crystal lattice arrangement, shown in FIG. 2D as a dark gray portion. In some examples, the different crystal lattice arrangements of regions sharing a twin boundary can be considered as mirror images of one another. In some examples, and as shown, the crystal grains 212, 214 can have similar shapes or different shapes. For example, the grain 212 is relative equiaxial, being slightly larger in one lateral dimension, while the grain 214 is relatively columnar. The degree to which the grains of the nanotwinned Cu—Co alloy material 210 are uniformly equiaxial, or a distribution of equiaxial and columnar can be varied by adjusting the process conditions for forming the nanotwinned Cu—Co alloy material, as described herein.

The nanotwinned Cu—Co alloy material can exhibit different properties as an effect of the increased Co2+ ion concentration. These properties are demonstrated in Table 1 below, which generally illustrates that an increase in Co to the alloy in the identified ranges can selectively modify the material properties, twin spacing, and grain size of the resulting alloys.

TABLE 1

| | 0M Co | | |
|---|---|---|---|
| [Co²⁺] | (pure Cu) | 0.1M Co | 0.5M Co |
| UTS (MPa) | 715.2 ± 8.6 | 809.2 ± 9.9 (+13%) | 812.9 ± 9.0 |
| YS (MPa) | 567.6 ± 6.2 | 621.6 ± 7.7 (+10%) | 605.7 ± 6.5 |
| EL (%) | 3.3 ± 0.3 | 3.5 ± 0.4 | 3.3 ± 0.5 |
| IACS (%) | 84 | 81 | 85 |
| Twin Spacing, nm | 110 | 92 | 57 |
| grain size, μm | 1.36 | 0.94 | 0.51 |

FIG. 2D shows a scanning electron micrograph of a cross-section of a nanotwinned Cu—Co alloy material 230 formed at 0.1M concentration Co and at 17° C. electrolyte temperature. Decreasing the temperature of the electrolyte during formation can further act to refine the microstructure and increase strength of the alloy, without materially impacting the electrical conductivity. The decreased temperature also reduces the overall grain size. In some examples, the lower electrolyte temperature can form smaller columnar grains and reduce twin spacing. Similar to that shown in FIG. 2C, the micrograph of FIG. 2D shows a first crystal grain 232 and a second, adjacent crystal grain 234. The crystal grain 230 includes a number of twin boundaries that are spaced apart from one another by between about 2-5 nm. In some examples, the crystal grains of a nanotwinned metal alloy, such as nanotwinned Cu—Co alloy material 230 described herein, can include twin boundaries spaced apart from one another by less than about 200 nm, less than about 150 nm, less than about 100 nm, less than about 75 nm, less than about 50 nm, less than about 25 nm, less than about 20 nm, less than about 15 nm, less than about 10 nm, less than about 5 nm, or less than about 2 nm or smaller.

The nanotwinned Cu—Co alloy material can exhibit different mechanical properties as an effect of the decreased electrolyte temperature. These properties are demonstrated in Table 2 below which illustrates the varying mechanical properties observed with a consistent electrolyte while only varying the electrolyte temperature during electrodeposition.

TABLE 2

| Temperature | 25° C. | 20° C. | 17° C. |
|---|---|---|---|
| UTS (MPa) | 809.2 ± 9.9 | 858.2 ± 3.71 (+6.1%) | 866.8 ± 4.52 (+7.1%) |
| YS (MPa) | 621.6 ± 7.7 | 637.5 ± 3.04 (+2.6%) | 640.4 ± 6.20 (+3%) |
| EL (%) | 3.5 ± 0.4 | 4.0 ± 0.38 | 3.3 ± 0.37 |
| IACS (%) | 81 | 86 | 82 |
| Twin Spacing, nm | 92 | | 83 |
| grain size, μm | 0.94 | | 0.48 |

In at least one example, after forming the nanotwinned Cu-based alloy materials described herein, the materials can then be subject to an annealing process. For example, the nanotwinned Cu—Co alloy materials shown in FIGS. 2C and 2D were formed using an electroplating process followed by a subsequent annealing step.

In at least one example, the annealing process used on nanotwinned Cu-based alloy materials can include subjecting the nanotwinned Cu-based alloy materials to a temperature of 200-Celcius for one hour under protective argon gas. In at least one example, the alloy materials described herein can be subjected to 200-Celcius for up to 5 hours or more. Longer annealing times may result in improved thermal stability of the material. Further, the nanotwin structure has good stability against thermal aging.

Along these lines, TABLE 3 below shows properties of including an annealing step for the alloy material and the effects of annealing. In some examples, the annealing helps stabilize the fine microstructure of alloy materials. As shown, annealing at 200-Celcius for one hour does not reduce the hardness for Cu—Co alloys. In addition, in at least one example, this annealing step can increase conductivity. In some examples, a nano-grained electroplated Cu has relatively poor thermal stability, wherein the grain size can coarsen at higher temperatures. For example, between about 20° C. or at a slightly elevated temperature, the grain size is observed to coarsen, resulting in lower strength. The twin boundaries provide a more thermally stable structure than regular grain boundaries, even after 200° C. for 5 hours as shown below.

TABLE 3

| Annealing | | | |
|---|---|---|---|
| Temperature & | None (as- | | |
| Time | deposited) | 200° C.-1 hr | 200° C.-5 hr |
| UTS (MPa) | 866.8 ± 4.52 | 812.0 ± 5.10 (−6.3%) | 780.5 ± 1.21 (−10%) |
| YS (MPa) | 640.4 ± 6.20 | 610.6 ± 3.94 (−4.7%) | 588.4 ± 2.50 (−8.1%) |
| EL (%) | 3.3 ± 0.37 | 3.0 ± 0.30 | 3.1 ± 0.16 |
| IACS (%) | 82 | 86 | 84 |
| grain | 0.48 | 0.50 | 0.56 |
| size, μm | | | |

Further, despite the properties exhibited as a result of the electrodeposition of Cu—Co and the capabilities of achieving a combination of >800 MPa tensile strength and >80% IACS conductivity, the Co ion is not significantly introduced into the deposited film. Rather, the microstructure refinement effect is due to the increase of Cu reduction over-potential. Particularly, in some examples, about 4.6 ppm of Co can be found in the resulting substrate foil.

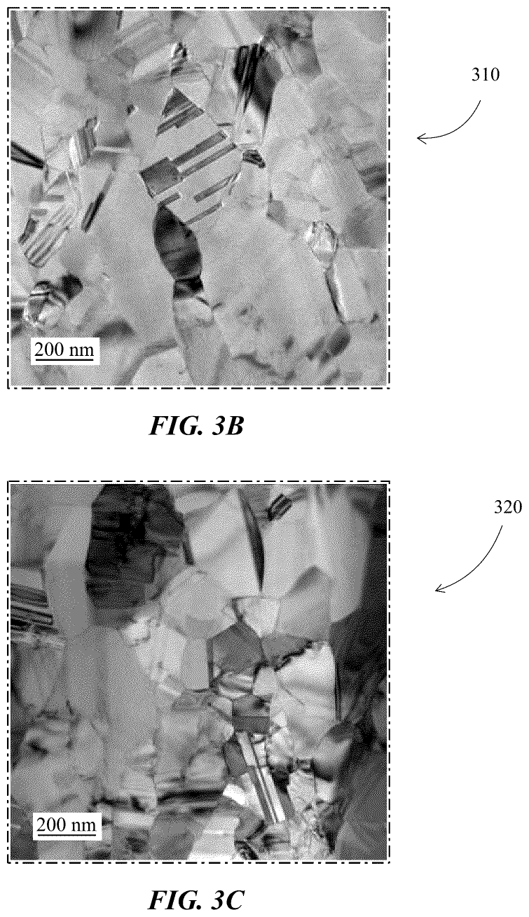

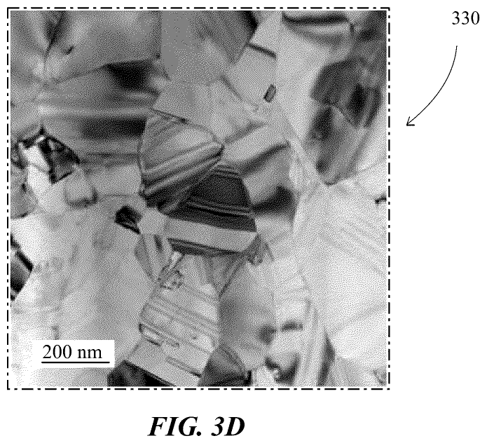

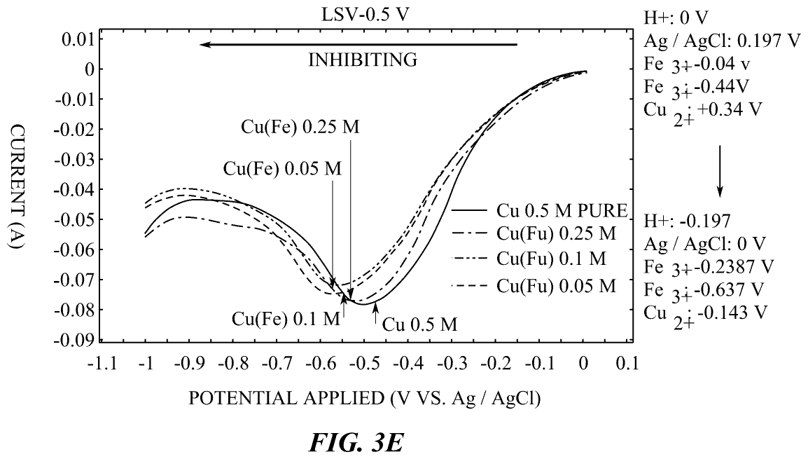

In other examples, other Cu-based alloys, other than Cu—Co alloys, can be used to create nano-twinned alloy materials having improved strength while only minimally affecting conductivity. As discussed above, iron (Fe) can be alloyed with copper to yield similarly beneficial effects and properties. FIGS. 3A-3E illustrate nanotwin structures of a Cu—Fe alloy substrate.

FIG. 3A shows a transmission electron micrograph 300 of a cross-section of nanotwinned pure copper (Cu) material. The material includes crystal grains, which can be seen in FIG. 3A. The pure copper material columnar grains and the grains can include nanotwin boundaries. FIG. 3B shows a scanning electron micrograph 310 of a cross-section of a nanotwinned Cu—Fe alloy material 200 at 0.05M concentration Fe. The nanotwinned Cu—Fe alloy includes crystal grains, where the iron is shown to refine the grain sizes and enhance strength of the material. In some examples, the crystal grains including a metallic material that can be relatively uniform in size, or can vary from small to large, depending on how the material was formed and/or treated. In some examples, nanotwinned Cu—Fe alloys, as described herein, can have an average grain size of between 0.19 microns and 0.26 microns, between 0.05 microns and 0.3 microns, between 0.1 microns and 0.2 microns. For example, the nanotwinned Cu—Fe alloys can have an average grain size of about 0.192 microns.

FIG. 3C shows a scanning electron micrograph 320 of a cross-section of a nanotwinned Cu—Fe alloy material at 0.1M concentration Fe. FIG. 3D shows a scanning electron micrograph 330 of a cross-section of a nanotwinned Cu—Fe alloy material at 0.25M concentration Fe. Increasing the Fe2+ ion concentration can act to refine the microstructure and increases strength of the alloy, without substantially impacting the electrical conductivity. Further, the increased Fe2+ ion concentration reduces the overall grain size. In some examples, the Fe2+ ion concentration can form smaller columnar grains and reduce twin spacing. The crystal grain can include a number of twin boundaries that are spaced apart from one another by between about 2-5 nm. In some examples, the crystal grains of a nanotwinned Cu—Fe alloy material can include twin boundaries spaced apart from one another by less than about 200 nm, less than about 150 nm, less than about 100 nm, less than about 75 nm, less than about 50 nm, less than about 25 nm, less than about 20 nm, less than about 15 nm, less than about 10 nm, less than about 5 nm, or less than about 2 nm or smaller.

The nanotwinned Cu—Fe alloy material can exhibit different properties as an effect of the increased Fe2+ ion concentration. These properties are demonstrated in Table 4 below. The addition of Fe ions results in strengthening with minimum impact to elongation and conductivity.

TABLE 4

| | 0M Fe | | | |
|---|---|---|---|---|
| [Fe²⁺] | (pure Cu) | 0.05M Fe | 0.1M Fe | 0.25M Fe |
| UTS (MPa) | 758.6 | 862.5 | 854.3 | 837.4 |
| YS (MPa) | 558.1 | 620.2 | 600 | 597.8 |
| EL (%) | 3.3 | 3.7 | 3.5 | 3.8 |
| IACS (%) | 83.7 | 80 | 82.1 | 79 |
| Twin Spacing, nm | 36.3 | 25.4 | 29.2 | 29.4 |
| grain size, μm | 0.253 | 0.192 | 0.192 | 0.192 |

As discussed above, the annealing process can also be used on nanotwinned Cu—Fe alloy materials by subjecting the nanotwinned Cu—Fe alloy materials to a temperature of 200-Celcius for at least one hour under protective argon gas. In at least one example, the alloy materials described herein can be subjected to 200-Celcius for up to 5 hours or more. Longer annealing times may result in improved thermal stability of the material. As discussed above, the twin boundaries provide a more thermally stable structure than regular grain boundaries even at higher temperatures.

TABLE 5 below shows properties comparing a 0.05M Fe Cu—Fe alloy with the same alloy after annealing. In some examples, the annealing helps stabilize the fine microstructure of alloy materials. As shown, annealing at 200-Celcius for five hours slightly reduces the strength of the alloy, but also improves the conductivity.

TABLE 5

| | 0.05M Fe, as | 0.05M Fe after | |
|---|---|---|---|
| [Fe²⁺] | deposited | 200° C./5 hr | |
| UTS (MPa) | 862.5 | 761.3 | (−11.7%) |
| YS (MPa) | 620.2 | 563.8 | (−9.1%) |
| EL (%) | 3.7 | 3.6 | (−0.1%) |
| IACS (%) | 80 | 86.4 | (+6.4%) |

FIG. 3E shows a graph of Linear Sweep Voltammetry (LSV) results for Cu—Fe alloy materials at various concentrations of Fe. LSV is a method of voltammetry where the current at a working electrode is measured while the potential between the working electrode and a reference electrode is swept linearly in time. Oxidation or reduction of species is registered as a peak or trough in the current signal at the potential at which the species begins to be oxidized or reduced. Linear sweep voltammetry can identify unknown species and determine the concentration of solutions. The potential applied can be used to identify the unknown species while the height of the limiting current can determine the concentration. As shown in FIG. 3E, incorporating Fe ions decrease overall current efficiency compared with pure copper. Fe ions suppress the growth of copper foil and increase the reduction over-potential. In other words, Fe2+ ions function as inhibitors. However, as shown, higher concentration Fe ions when greater than 0.05M weakens the inhibitory effects. Further, the increment of over-potential implies higher nucleus density, indicating smaller grain size.

Further, despite the properties exhibited as a result of the electrodeposition of Cu—Fe and the capabilities of achieving a combination of >800 MPa tensile strength and >78% IACS conductivity, the Fe ion is not significantly introduced into the deposited film. The microstructure refinement effect is due to the increase of Cu reduction over-potential. According to one example, less than 1 ppm of Fe could be found in the substrate foil.

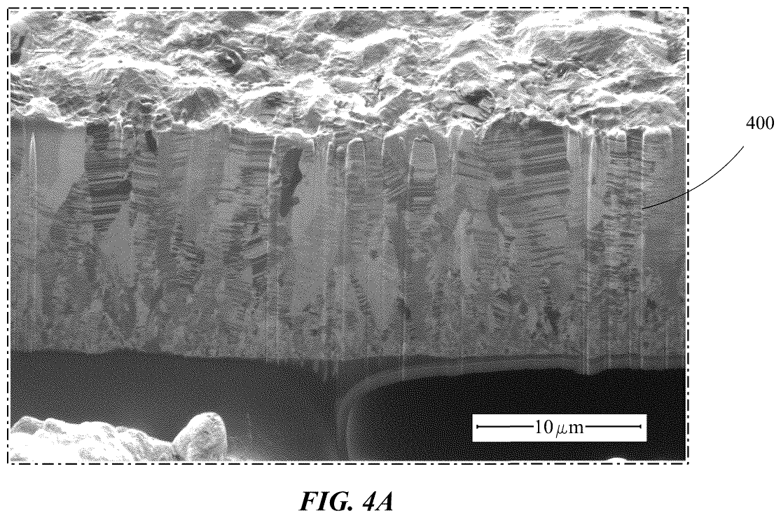

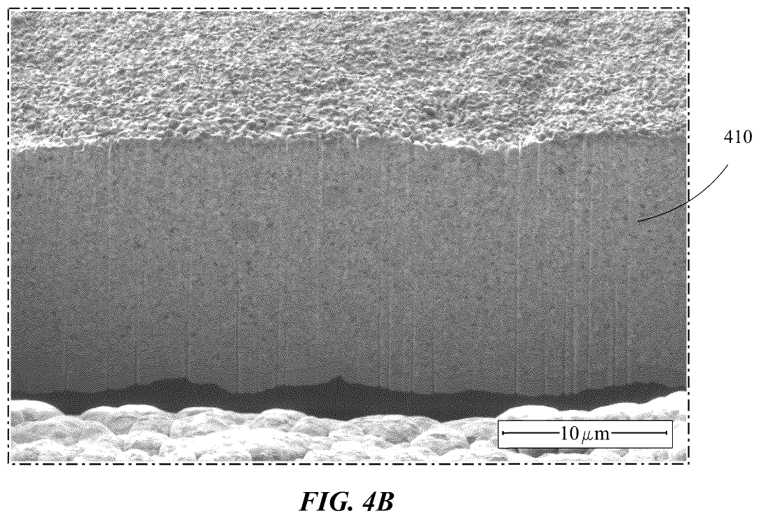

FIG. 4A shows a transmission electron micrograph of a cross-section of a nanotwinned Cu material 400. The pure copper material includes columnar grains, and the grains can include nanotwin boundaries. In some examples, substantially all or 100% of the crystal grains of a metallic material can include multiple nanotwins. In some examples, greater than 50%, greater than 60%, greater than 70%, greater than 75%, greater than 80%, greater than 85%, greater than 90%, greater than 91%, greater than 92%, greater than 93%, greater than 94%, greater than 95%, greater than 96%, greater than 97%, greater than 98%, or greater than 99%, or more of the crystal grains of a metallic material can include multiple nanotwins.

FIG. 4B shows a transmission electron micrograph of a cross-section of a nanotwinned Cu—Pd alloy material 410. Similar to the Cu—Co and Cu—Fe alloys, adding Pd to the Cu can be shown to refine the grain and reduce twin spacing. In some examples, Pd²⁺ can be added at 40 ppm, or equivalent to 0.00036M or 0.076 g/L PdSO₄. In contrast to the Cu—Co and Cu—Fe alloys, Pd is present in the Cu foil in much greater quantities. For example, when there is a Pd²⁺ ion concentration of 40 ppm, Pd is present in the Cu foil at 0.26 wt %. When there is a Pd²⁺ ion concentration of 200 ppm, Pd is present in the Cu foil at 0.78 wt %. When there is a Pd²⁺ ion concentration of 400 ppm, Pd is present in the Cu foil at 1.36 wt %. When there is a Pd²⁺ ion concentration of 10100 ppm, Pd is present in the Cu foil at 3.55 wt %. In some examples, the Pd deposit in the Cu foil is located at the grain boundaries. The Pd at the grain boundaries increases the tensile strength of the Cu—Pd alloy, compared to a pure copper foil. In some examples, adding Pd can result in at least 20% enhancement on the tensile strength (UTS).

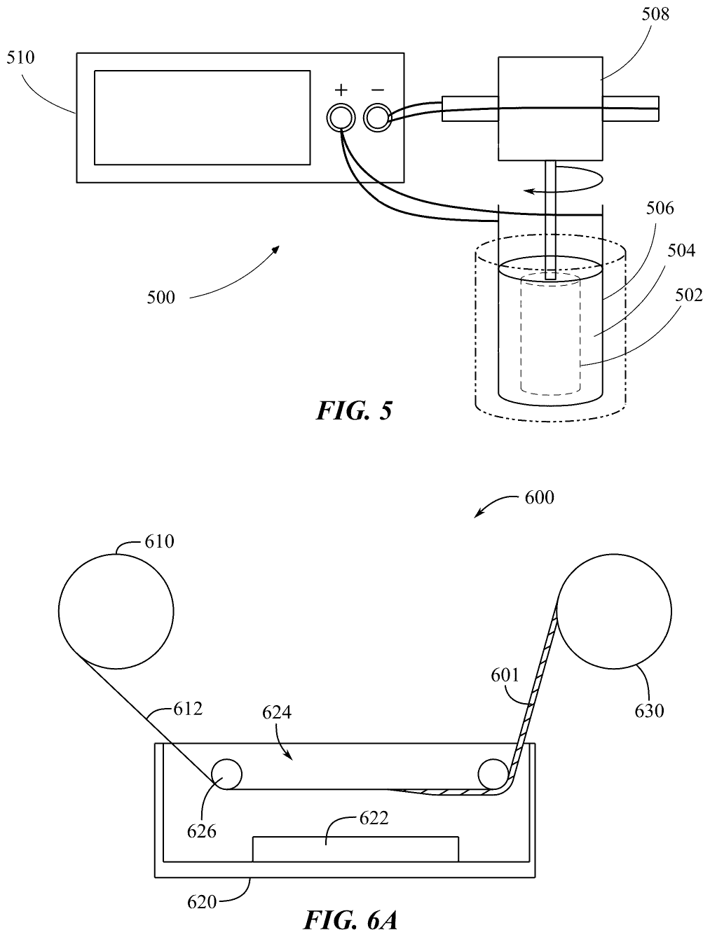

FIG. 5 shows an electroplating system 500 for forming a nanotwinned alloy material. In at least one example, electrical conductivity (International Annealed Copper Standard, IACS) of copper foil was measured using a Loresta-GX instrument (MCP-T700, Nittoseiko Analytech, Japan). In some examples, electroplating can include a carrier or substrate, such as a titanium rotary cylinder electrode 502, at least partially immersed in an electrolyte solution 504. The electrolyte solution can include an aqueous copper sulfate (CuSO₄), an aqueous cobalt sulfate (CoSO₄), an iron sulfate (FeSO₄), or a palladium sulfate (PdSO₄); a hydrochloric acid (HCl); and/or a Cheerleader DP-101L additive 20 mL/L. The electrolyte solution 504 can be within an IrO2 anode 506. The titanium rotary cylinder electrode 502 can be selectively rotated by a modulated speed rotator 508. The titanium rotary cylinder electrode 502 can receive a negative electrical charge from a power source 510, and the IrO2 anode can receive a positive charge from the power source 510 during deposition.

When forming a Cu—Co alloy, the electrolyte can include approximately 0.06-1.0M of CuSO₄ and between about 0.1M and about 0.5M CoSO₄. When forming a Fe—Co alloy, the electrolyte can include approximately 0.5-1.0M of CuSo₄ and between about 0.1M and about 0.5M FeSO₄. When forming a Cu—Pd alloy, the electrolyte can include approximately 0.06-1.0M of CuSo₄ and between about 0.0003M and about 0.0004M PdSO₄.

The current density of the electroplating can include between approximately 12 and 28 amperes per square decimeter (ASD). The current density of the electroplating in this example can include about 15 ASD for Cu—Co alloys, about 25 ASD for Cu—Fe alloys, and about 25 ASD for Cu—Pd alloys.

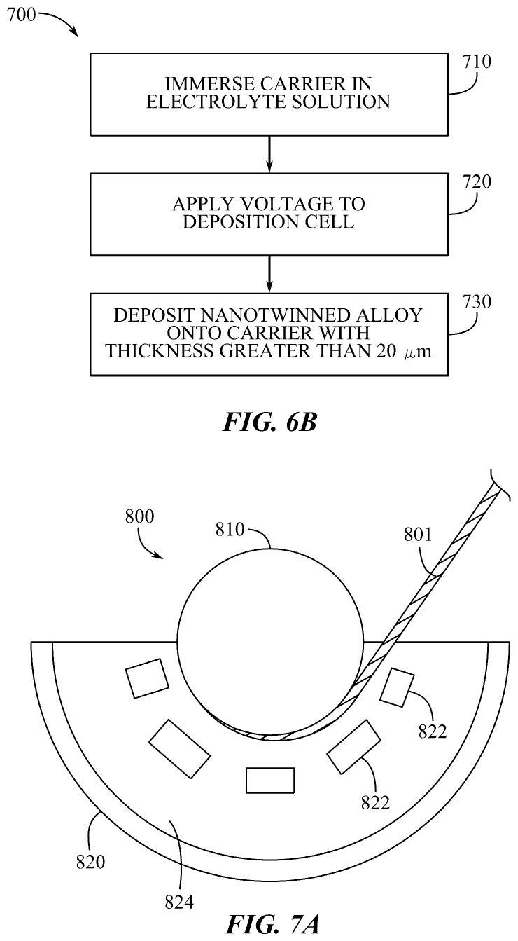

FIG. 6A illustrates a schematic diagram of a system 600 for forming a nanotwinned metallic alloy material 601, such as the nanotwinned Cu—Co, Cu—Fe, or Cu—Pd alloys described herein, using an electroplating process. In some examples, the system 600 can include a carrier or substrate 612 that can be fed through, and pass between, any number of rollers, wheels, spools, or other apparatuses or mechanisms for moving and/or supporting the carrier 612. In some examples, the carrier 612 can be a sheet or film of material. For example, the carrier 612 can include a polymeric material, a metallic material, and/or combinations thereof. In some examples, the carrier 612 can be flexible and can be rolled up or stored in an otherwise compact manner, and then unwound and fed through the system 600. In some examples, the carrier 612 can be electrically conductive or can include electrically conductive materials. In the present example, the carrier 612 can be wound around a first spool 610, whereupon it can pass under or otherwise interact with rollers or support components, such as roller 626, before being wrapped around a second spool 660 once a nanotwinned Cu-based alloy material has been formed thereon. Accordingly, in use, the carrier 612 can be fed from the first spool 610 onto the second spool 660 during the deposition of the nanotwinned Cu-based alloy material 601. The presently illustrated system 600 is just one example of a system for forming a nanotwinned metallic alloy material 601, and such a system can have any geometry or configuration, as desired. In other words, a method for forming a component can include electroplating a metallic material having crystal grains onto a carrier, one or more of the crystal grains including nanotwin boundaries. The metallic material includes a copper (Cu) alloy having less than about 40 ppm cobalt (Co), iron (Fe), or Palladium (Pd).

In some examples, the carrier 612 can be at least partially immersed after being fed from the first spool 610 into a deposition tank, bath, or chamber 620. In some examples, the deposition bath 620 can be an electrodeposition or electroplating bath 620. Thus, in some examples, the deposition bath 620 can contain an electrolyte solution 624 and can include one or more anodes 622 at least partially immersed in the electrolyte solution 624. During a nanotwinned metallic alloy material 601 deposition process, an electrical current can be provided to the anode 622 immersed in the electrolyte solution 624, with the carrier 612 acting as the cathode in the deposition cell. In some examples, the electrolyte solution 624 contains dissolved cations of the metal or metals that are to be deposited onto the carrier 612. For example, where a nanotwinned Cu-based alloy is being deposited, the electrolyte solution 624 can include copper cations and cobalt, iron, or palladium cations.

In at least one example, the electrolyte solution 624 can include Cu ion sources such as CuSO₄ and/or Cu(NO₃)₂ and Co, Fe, or Pd ion sources can include compositions such as CoSO₄, FeSO₄, or PdSO₄ respectively. In at least one example, additional chemical additives can be added to the electrolyte solution 624 having functions such as accelerators (to improve grain structure), suppressors (to improve plating uniformity and selecting specific grain orientation), and wetting agents (removing H₂ bubbles from the surface).

In some examples, the electrolyte solution 624 can contain other constituent materials, such as associated anions, a suppressor agent or agents, and/or constituents to adjust the properties of the solution, such as the viscosity or pH. In some examples, a suppressor agent can be any constituent that can prevent or inhibit the formation of deposition hotspots on the carrier surface. That is, locations where material can be deposited preferentially as compared to other surface locations. Thus, in some examples, a suppressor agent can allow for relatively uniform deposition across the entire immersed surface of a carrier 612. In some examples, a suppressor agent can include water-soluble mono- or co-polymers. In some examples, a suppressor agent can include one or more polymeric compounds such as polyethylene glycol (PEG) or bis(3-sulfopropyl) disulfide (SPS). In some examples, other compounds or elements can serve as suppressor agents, such as chloride ions (Cl−).

In some examples, the electrolyte solution can include Cu ions as the cation, for example Cu²⁺ ions. In some examples, the corresponding anion can include SO₄²⁻ ions or any other ions. In some examples, the electrolyte solution can include compounds such as H₂SO₄ or other components to adjust the pH of the solution or contribute anions. In some examples, the electrolyte solution can include constituents such as one or more deposition accelerators and wetting agents.

In some examples, the electric current drives a reduction reaction which deposits or plates the metal cations onto the carrier 612 in the form of a nanotwinned metallic alloy material 601. Further, as the carrier 612 is fed from the first spool 610 to the second spool 630 through the electroplating bath 620, the nanotwinned metallic alloy material 601 is progressively deposited over the length of the carrier 612 to a desired thickness. Accordingly, the system 600 can be used to form a foil, sheet, or film of nanotwinned metallic alloy material 601 onto the carrier 612. In some examples, the deposited nanotwinned metallic alloy material 601 can have a thickness from about 4 microns up to several millimeters, for example, less than about 10 microns, at least about 50 microns, or even up to about 10 mm. In some examples, the thickness of the nanotwinned metallic alloy material 601 can be substantially uniform across the entire carrier 612. In some examples, however, the thickness of the deposited nanotwinned metallic alloy material 601 can vary across the length and width of the carrier 612, as desired.

FIG. 6B illustrates a process flow diagram of an exemplary process 700 for depositing or forming a nanotwinned metallic material, as described herein, such as nanotwinned metallic material 601 deposited onto the carrier 612 by the system 600. The process 700 for depositing the nanotwinned metallic material can be an electrodeposition or electroplating process, and can include immersing a carrier in an electrolyte solution at block 710, applying a voltage to a deposition cell including the carrier and the electrolyte solution at block 720, and depositing the nanotwinned metallic alloy material, such as nanotwinned Cu-based alloy material, onto the carrier to a desired thickness, for example, 1-5 microns, 5-10 microns, 10-20 microns, 20-50 microns, or greater than about 50 microns, at block 730.

At block 710, a carrier is at least partially immersed in an electrolyte solution. In some examples, this can include at least partially immersing a carrier, such as carrier 612 illustrated with respect to FIG. 6A, in an electrolyte solution including cations of the metal that is to be deposited or formed. In some examples, the carrier can be at least partially immersed in an electroplating bath, for example, as shown in FIG. 6A, although any suitable immersion technique and electrolyte solution container can be used.

At block 720, a voltage is applied to a deposition cell including the carrier and the electrolyte solution. In some examples, the deposition cell can include a cathode, such as the carrier, onto which the nanotwinned metallic alloy material is to be deposited, an electrolyte solution, and an anode. For example, as shown in FIG. 6A, the deposition cell can include the carrier 612, the deposition bath 620 including the electrolyte solution 624, and the anode, 622. The voltage can drive an alternating current or a direct current and can be applied so as to achieve a desired current density or range of current densities at the carrier. In some examples, such as when direct current is applied or driven to the deposition cell, the current density at the location or locations on the carrier where nanotwinned metallic alloy material is deposited can be from about 1 amperes per square decimeter (ASD) to about 500 ASD. In some examples, the current density at the location on the carrier where nanotwinned metallic material is deposited can be greater than or equal to about 10 ASD, greater than or equal to about 50 ASD, greater than or equal to about 100 ASD, greater than or equal to about 250 ASD or greater than or equal to about 500 ASD or more. In some examples, the current density can be about 15 ASD.

In some examples, alternating current, or pulsed direct current, can be applied to the deposition cell. In some examples where pulsed current is applied to the deposition cell, the current density at locations on the carrier where nanotwinned metallic material is deposited can be between about 1 ASD and about 500 ASD during the pulse. For example, the current density at the location on the carrier where nanotwinned metallic material is deposited can be greater than or equal to about 1 ASD, greater than or equal to about 10 ASD, greater than or equal to about 50 ASD, greater than or equal to about 100 ASD, greater than or equal to about 250 ASD, or greater than or equal to about 500 ASD or more. In some examples, the current density can be about 80 ASD during the pulses.

In some examples, a pulse or pulses of the pulsed current can have a duration between 2 and about 500 milliseconds (ms). For example, one or more pulses of the pulsed current can have a duration greater than or equal to about 2 ms, greater than or equal to about 50 ms, greater than or equal to about 100 ms, greater than or equal to about 250 ms, or greater than or equal to about 500 ms or more. In some examples, a pulse or pulses can have a duration of about 3 ms. In some examples, the duration or durations between pulses can remain the same between each pulse or can vary as the deposition process is carried out. For example, the duration between each pulse can be from 10 to about 3000 ms. In some examples, the duration between pulses can be greater than or equal to 10 ms, greater than or equal to 100 ms, greater than or equal to 500 ms, greater than or equal to 1000 ms, greater than or equal to 2000 ms, or greater than or equal to 3000 ms or more. In some examples, the duration between pulses can be about 25 ms. Similarly, the pulse times can be varied through the deposition process 700.

At block 730, a nanotwinned metallic alloy material is deposited onto at least a portion of the carrier, for example, a portion of the carrier immersed in the electrolyte solution, to a thickness. In some examples, the nanotwinned alloy metallic material can include Cu-based alloys described herein. In some examples, the nanotwinned metallic alloy material can be deposited to a thickness greater than or equal to about 3 microns, greater than about 10 microns, greater than or equal to about 20 microns, greater than or equal to about 50 microns, or greater than or equal to about 100 microns. In some examples, the nanotwinned metallic alloy material can be deposited to any desired thickness described herein.

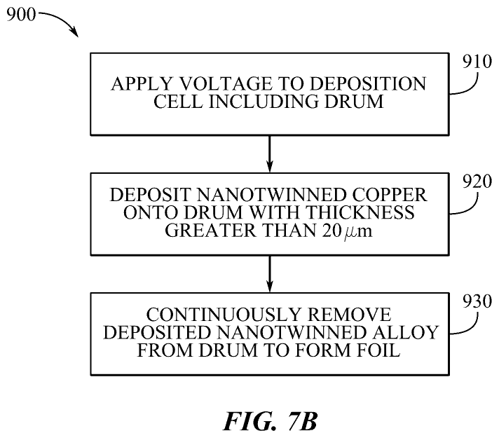

Although illustrated as a separate block, the deposition of the nanotwinned metallic alloy material at block 730 can occur because of the voltage applied at block 720, and thus may not be a separate process step. Further details of systems and processes for forming nanotwinned metallic materials are described with respect to FIGS. 7A-7B.

FIG. 7A illustrates a schematic diagram of a system 800 for forming a nanotwinned metallic material 801. In some examples, the system 800 can include a carrier or substrate 810 that can be at least partially immersed in an electrolyte solution 824 that is contained or otherwise held in a deposition tank 820. In some examples, the carrier 810 can include a conductive material, such as a metallic material. In some examples, the carrier 810 can include titanium or aluminum. In some examples, the carrier 810 can have a substantially cylindrical shape and can take the form of a drum. In some examples, however, the carrier 810 can have substantially any desired shape. In the present example, the carrier 810 is partially immersed in the electrolyte solution 824, and can rotate so that the portion immersed in the electrolyte solution 824 can be moved out of the solution and any nanotwinned metallic alloy material 801 deposited thereon can be removed, for example, in a continuous manner. The presently illustrated system 800 is just one example of a system for forming a nanotwinned metallic alloy material 801, and such a system can have any geometry or configuration desired.

In some examples, the electrolyte solution 824 can be substantially similar to, and can include some or all of the features of the electrolyte solution 624 described herein. The deposition bath can further include one or more anodes 822 that can be positioned proximate to the carrier 810, which can function as a cathode during a deposition process, such as an electrodeposition or electroplating process. In some examples, a voltage or electric current can be driven through a deposition cell including the anodes 822, electrolyte solution 824, and carrier 810.

In some examples, the electric current drives a reduction reaction which deposits or plates the metal cations onto the carrier 810 in the form of a nanotwinned metallic alloy material 801. Further, as the carrier 810 is rotated about an axis, the nanotwinned metallic alloy material 801 is progressively deposited over the immersed portions of the carrier 810 to a desired thickness. The deposited material 801 can then be removed from the carrier 810, for example, as a free-standing film, foil, or sheet. Accordingly, the system 800 can be used to form a foil, sheet, or film of nanotwinned metallic alloy material 801. In some examples, the deposited nanotwinned metallic alloy material 801 can have a thickness from about 4 microns up to several millimeters, for example, up to about 10 mm. In some examples, the thickness of the nanotwinned metallic alloy material 801 can be substantially uniform as it is formed. In some examples, however, the thickness of the deposited nanotwinned metallic alloy material 801 can vary across its length and width, as desired.

FIG. 7B illustrates a process flow diagram of an exemplary process 900 for depositing or forming a nanotwinned metallic alloy material, as described herein, such as alloy material 801 deposited onto the carrier 810 by the system 800. In some examples, The process 900 for depositing the nanotwinned metallic alloy material can be an electrodeposition or electroplating process, and can include applying a voltage to a deposition cell including an at least partially immersed drum at block 910, co-electroplating with ions of copper (Cu) and ions selected from the group consisting of cobalt (Co), iron (Fe), or Palladium (Pd), onto the drum to a desired thickness, for example, greater than about 20 microns, at block 920, and continuously removing the deposited nanotwinned metallic alloy material from the drum, at block 930, to form a foil.

At block 910, a voltage is applied to a deposition cell including a carrier, such as a metallic drum, which is at least partially immersed in an electrolyte solution. In some examples, the electrolyte solution exhibits a temperature between about 17° C. and about 25° C. In some examples, the deposition cell can include a drum or other carrier acting as a cathode onto which the nanotwinned metallic alloy material is to be deposited, an electrolyte solution, and one or more anodes. For example, as shown in FIG. 7A, the deposition cell can include the drum 810, the deposition bath 820 including the electrolyte solution 824, and the anodes 822. The voltage can be applied by driving an alternating current or a direct current and can be applied so as to achieve a desired current density or range of current densities at the carrier.

In some examples, such as when direct current is applied or driven to the deposition cell, the current density at the location or locations on the drum where nanotwinned metallic alloy material is deposited can be from about 1 ASD to about 25 ASD. In some examples, the current density at the location on the drum where nanotwinned metallic alloy material is deposited can be greater than or equal to about 2 ASD, greater than or equal to about 5 ASD, greater than or equal to about 10 ASD, or greater than or equal to about 15 ASD or more. In some examples, the current density can be about 12 ASD. In some examples, alternating current, or pulsed direct current can be applied to the deposition cell. In some examples where pulsed current is applied to the deposition cell, the current density at locations on the drum where nanotwinned metallic material is deposited, such as those locations immersed in the electrolyte solution, can be between about 1 ASD and about 500 ASD during the pulse. For example, the current density at the location on the carrier where nanotwinned metallic material is deposited can be greater than or equal to about 1 ASD, greater than or equal to about 10 ASD, greater than or equal to about 50 ASD, greater than or equal to about 100 ASD, greater than or equal to about 250 ASD, or greater than or equal to about 500 ASD or more. In some examples, the current density can be about 80 ASD during the pulses.

In some examples, a pulse or pulses of the pulsed current can have a duration between 2 and about 500 ms. For example, one or more pulses of the pulsed current can have a duration greater than or equal to about 2 ms, greater than or equal to about 50 ms, greater than or equal to about 100 ms, greater than or equal to about 250 ms, or greater than or equal to about 500 ms or more. In some examples, a pulse or pulses can have a duration of about 3 ms. In some examples, the duration or durations between pulses can remain the same between each pulse or can vary as the deposition process 900 is carried out. For example, the duration between each pulse can be from 10 to about 3000 ms. In some examples, the duration between pulses can be greater than or equal to 10 ms, greater than or equal to 100 ms, greater than or equal to 500 ms, greater than or equal to 1000 ms, greater than or equal to 2000 ms, or greater than or equal to 3000 ms or more. In some examples, the duration between pulses can be about 25 ms. Similarly, the pulse times can be varied through the deposition process 900.

At block 920, a nanotwinned metallic alloy material is deposited onto at least a portion of the drum, for example, a portion of the drum immersed in the electrolyte solution, to a desired thickness. In some examples, the nanotwinned metallic alloy material can include copper. In some examples, the nanotwinned metallic alloy material can include copper, silver, and/or an alloy thereof. In some examples, the nanotwinned metallic alloy material can be deposited to a thickness greater than or equal to about 20 microns, greater than or equal to about 40 microns, greater than or equal to about 50 microns, or greater than or equal to about 100 microns. In some examples, the nanotwinned metallic alloy material can be deposited to any desired thickness described herein.

At block 930, any nanotwinned metallic alloy material that has been deposited on the drum can be continuously removed from the drum to form a foil or sheet of nanotwinned metallic alloy material having a desired thickness. In some examples, the foil or sheet can be self-supporting. That is, the foil of nanotwinned metallic alloy material, as it is continuously removed from the drum, may not require a further carrier or support material to remain a single continuous foil.

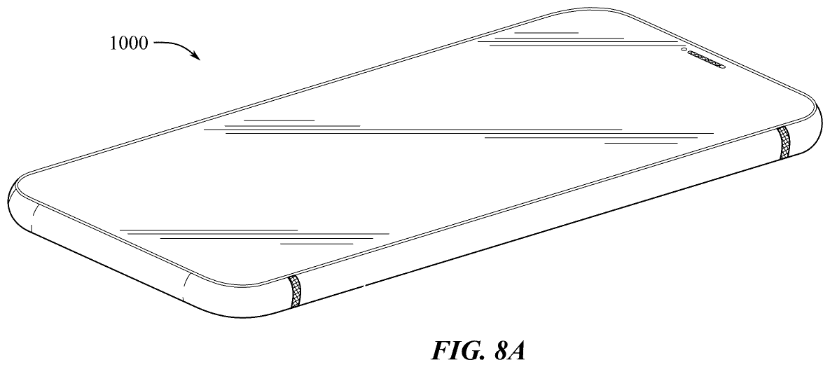

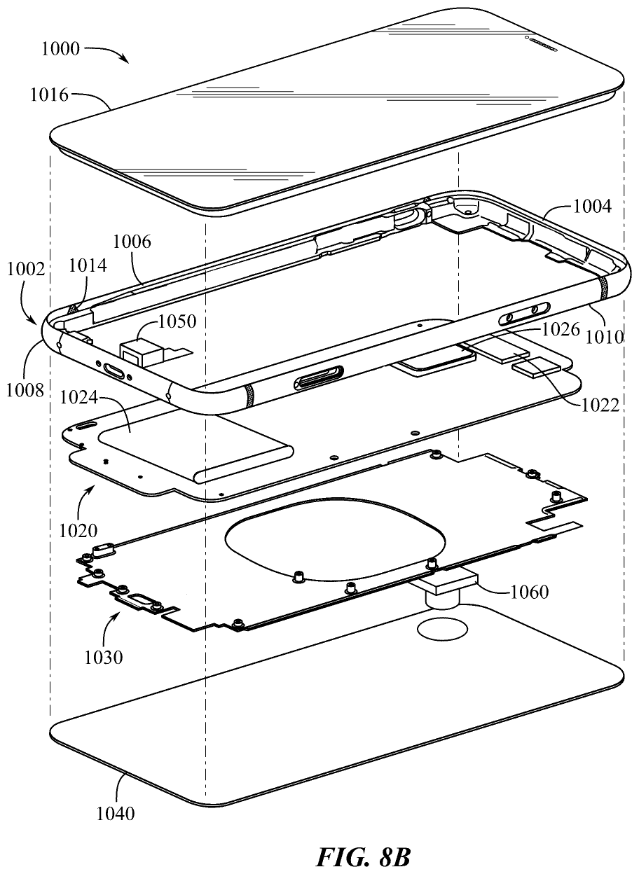

FIG. 8A illustrates a perspective view of an example of an electronic device 1000. The electronic device 1000 shown in FIG. 8A is a mobile wireless communication device, such as a smartphone. The smartphone of FIG. 8A is merely one representative example of a device that can be used in conjunction with the systems and methods described herein, and that can include one or more components and/or materials described herein. Electronic device 1000 can correspond to any form of a wearable electronic device, a portable media player, a media storage device, a portable digital assistant (“PDA”), a tablet computer, a computer, a mobile communication device, a GPS unit, a remote-control device, or any other electronic device. The electronic device 1000 can be referred to as an electronic device, or a consumer device.

FIG. 8B illustrates an exploded view of the electronic device 1000. The electronic device 1000 can have a housing that includes a frame or a band 1002 that defines an outer perimeter and a portion of the exterior surface of the electronic device 1000. The band 1002, or portions thereof, can be joined to one or more other components of the device, as described herein. In some examples, the band 1002 can include several sidewall components, such as a first sidewall component 1004, a second sidewall component 1006, a third sidewall component 1008 (opposite the first sidewall component 1004), and a fourth sidewall component 1010. The sidewall components can be joined, for example, at multiple locations, to one or more other components of the device, as described herein. The housing of the device 1000, for example, the band 1002, can include one or more features to receive or couple to other components of the device 1000. In some examples, one or more of the sidewall components 1004, 1006, 1008, 1010 can include a metallic material, such as steel.

In some examples, one or more of the sidewall components 1004, 1006, 1008, 1010 can include a nanotwinned metallic material, such as a nanotwinned copper alloy material. In some examples, an interior portion of one or more of the sidewall components 1004, 1006, 1008, 1010, such as a portion that at least partially defines an internal volume of the device 1000, can include the nanotwinned metallic material. In some examples, while some portion of one or more of the sidewall components 1004, 1006, 1008, 1010 can include a nanotwinned metallic alloy material, a second portion of one or more of the sidewall components 1004, 1006, 1008, 1010 can include an additional material, such as steel. For example, the interior portion of one or more of the sidewall components 1004, 1006, 1008, 1010 can include the nanotwinned metallic alloy material and an exterior or outer portion, such as a portion at least partially defining an exterior surface of the device 1000 can include a second, different material, such as steel. In some examples, however, the entirety of one or more of the sidewall components 1004, 1006, 1008, 1010 can be formed from the nanotwinned metallic alloy materials described herein. In some examples, one or more of the sidewall components 1004, 1006, 1008, 1010 can allow for one or more of the sidewall components 1004, 1006, 1008, 1010 to provide high levels of thermal conductivity, for example, via the nanotwinned metallic alloy material, to provide thermal management to the device 1000, while maintaining a desired hardness, durability and exterior finish for the device 1000.

In some examples, some of the sidewall components 1004, 1006, 1008, 1010 can form part of an antenna assembly (not shown). As a result, a non-metal material or materials can separate the sidewall components 1004, 1006, 1008, 1010 of the band 1002 from each other, in order to electrically isolate the sidewall components 1004, 1006, 1008, 1010. For example, a separating material 1014 separates the second sidewall component 1006 from the third sidewall component 1008. The aforementioned materials can include an electrically inert or insulating material(s), such as plastics and/or resin, as non-limiting examples. Further, as described herein, one or more of the sidewall components 1004, 1006, 1008, 1010 can be electrically or physically connected to internal components of the electronic device 1000, such as a support component 1030, as described herein. In some examples, these electrical connections can be achieved by joining a sidewall component 1004, 1006, 1008, 1010 to an internal component, for example, as part of the antenna assembly.

The electronic device 1000 can further include a display assembly 1016 that can include an outer protective layer or cover. The display assembly 1016 can include multiple layers, with each layer providing a unique function. In some examples, the outer layer, cover, or portion of the display assembly 1016 defining an external surface of the device 1000, can be considered part of the housing of the device. Further, the protective cover of the display assembly 1016 can include any transparent material, or combination of desired materials, such as polymeric material, and/or ceramic material such as sapphire or glass. In some examples, the display assembly 1016 can include a display component, such as a liquid crystal display (LCD) component or a light emitting diode (LED) display component. In some examples, the display assembly 1016 can include a touch sensitive layer and/or one or more touch sensors. In some examples, the display assembly 1016 can be received by, and/or be attached to, the band 1002 by one or more attachment features.

The device 1000 can include internal components, such as a system in package (SiP) 1026, including one or more integrated circuits such as a processors, sensors, and memory. The device 1000 can also include a battery 1024 housed in the internal volume of the device 1000. Additional components, such as a haptic engine 1022, can also be included in the device 1000. In some examples, one or more of these internal components can be mounted to a circuit board 1020 that can be joined or affixed to other components of the device 1000, such as the band 1002. In some examples, and as described herein, one or more of the components such as the SiP 1026 and the battery 1024 can include nanotwinned metallic alloy materials. In some examples, the device 1000 can include additional components that include nanotwinned metallic alloy materials. For example, the device 1000 can include an electrical connector receptacle 1050 and/or a camera module 1060 that include nanotwinned metallic alloy materials.

The electronic device 1000 can further include a support component 1030, also referred to as a support plate, back plate, or chassis, which can perform a number of functions. For example, the support component 1030 can provide structural support for the electronic device 1000. The support component 1030 can include a rigid material, such as a metal or metals, as described herein. In some examples, the support component 1030 can aid in the thermal management of the device 1000, such as by acting as a thermal spreader or heat sink for one or more components of the device. In some examples, the support component 1030 can include a nanotwinned metallic alloy material than can transport thermal energy or heat from a component of the device 1000 to one or more other desired locations or other components of the device 1000. For example, the SiP 1026 can produce a thermal load during operation and can be thermally coupled to the support component 1030. At least some of the thermal load of the SiP can be transferred to the support component 1030, whereupon this thermal energy can be distributed throughout the support component 1030 and/or to one or more other components connected thereto.

In some examples, the support component 1030 can include nanotwinned metallic copper alloy material. The support component 1030 can be physically, electrically, and/or thermally coupled to the band 1002. In this manner, the support component 1030 can, for example, provide an electrical grounding path for components electrically coupled to the support component 1030, such as a compass or an antenna. The support component 1030 can also include one or more attachment features such that one or more components of the electronic device 1000 can be attached to the support component 1030, for example, by fasteners and/or by welding, as described herein. In some examples, the support component 1030 can be joined to the band 1002 of the device 1000 at one or more locations by any desired method, such as welding. The advantageous properties of the nanotwinned metallic alloy materials described herein can allow for the support component 1030 to achieve desired levels of thermal and electrical conductivity, while also providing desired levels of mechanical support.

An exterior surface of the electronic device 1000 can further be defined by a back cover 1040 that can be coupled to one or more other components of the device 1000. In this regard, the back cover 1040 can combine with the band 1002 to form an enclosure or housing of the electronic device 1000, with the enclosure or housing (including band 1002 and back cover 1040) at least partially defining an internal volume. The back cover 1040 can include a transparent material such as glass, plastic, sapphire, or combinations thereof. An inner portion of the back cover 1040 can be bonded, such as with an adhesive, to the support component 1030. The portion of the support component 1030 that is bonded to the back cover 1040 can protrude relative to other peripheral portions thereof, so that welds can be provided within a space that can be between the support component 1030 and the back cover 1040 when the device 1000 is assembled. This clearance can allow the parts to be assembled without interference between welds on the support component 1030 and the back cover 1040. Additionally, or alternatively, the back cover 1040 can be bonded directly to the band 1002 or coupled to the band 1002 by an interference or other mechanical engagement.

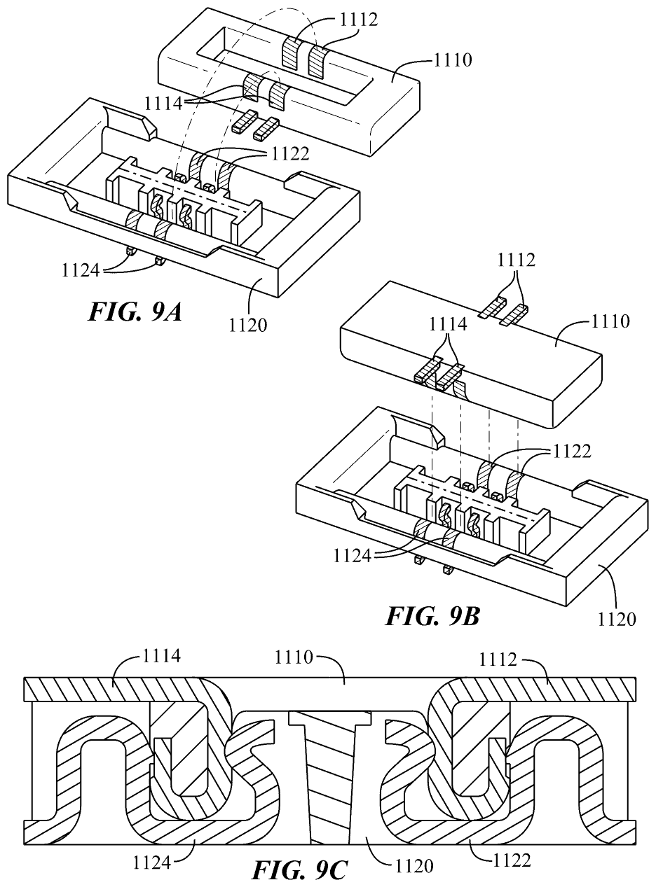

FIG. 9A illustrates a perspective view of a first electrical connector 1110 and a second corresponding electrical connector 1120. In some examples, the electrical connectors 1110 and 1120 can be designed to interlock and connect with one another such that an electrical connection is formed therebetween. In some examples, the connectors 1110 and 1120 can be electrically coupled to one or more components of an electronic device, such as device 1000, and can be used to electrically couple or connect the components to one another. For example, the electrical connector 1110 can be coupled to, or can be a part of a component such as the SiP 1026 described with respect to FIG. 8B, while the connector 1120 can be coupled to, or can be a part of a component such as the PCB 1020. In some examples, the connectors 1110, 1120, can be board-to-board connectors, or can couple any other components or a device together.

In some examples, the connector 1110 can include first electrical contact portions 1112 and second electrical contact portion 1114. In some examples, these contact portions 1112, 1114 can include nanotwinned metallic alloy material, such as nanotwinned Cu-based alloys. Similarly, the connector 1120 can include first contact portions 1122 designed to contact and couple with first contact portions 1112, and second contact portions 1124 designed to contact and couple with second contact portions 1124. The contact portions 1122, 1124 can also include or be formed from nanotwinned metallic alloy material, such as nanotwinned Cu-based alloys described herein.

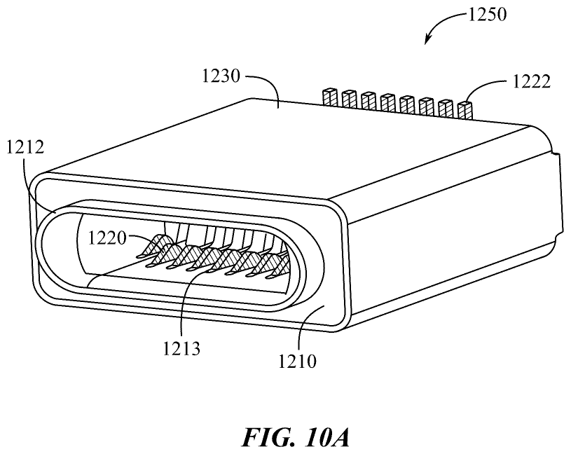

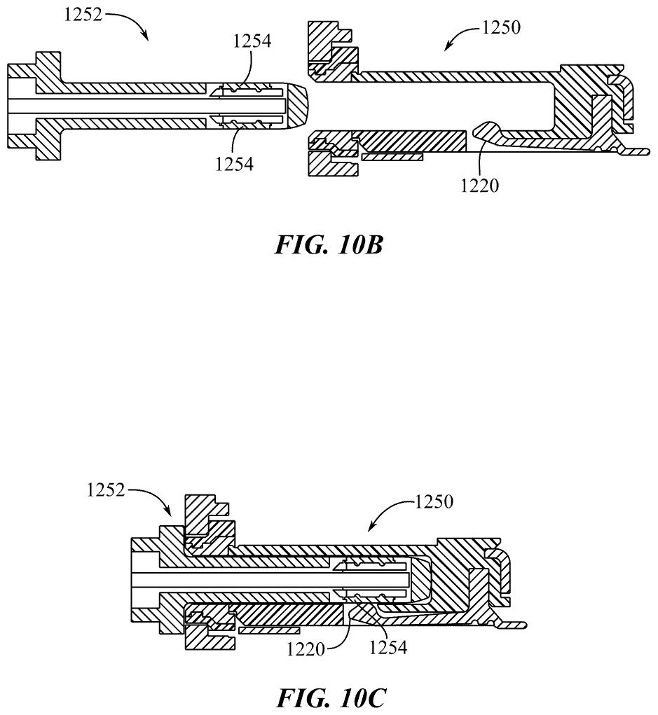

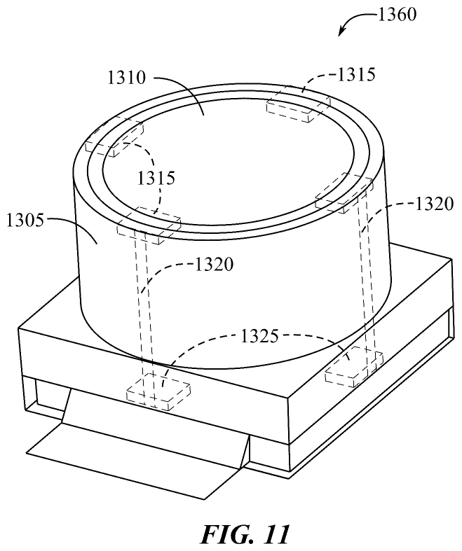

FIG. 9B shows a perspective view of the electrical connectors 1110, 1120 arranged opposite and in line with one another prior to being connected, for example, as they might be arranged prior to assembly of the components of an electronic device. As can be seen, the connector 1120 can receive the connector 1110 and the contact portions 1112, 1114, and 1122, 1124 of each connector can be configured to mechanically and electrically contact one another. FIG. 9C shows a cross-sectional view of the electrical connectors 1110, 1120 in a connected state. As can be seen, the contact portions 1112, 1114, 1122, 1124 can overlap one another and can be designed to deform slightly to provide a secure connection therebetween. Accordingly, the material forming the contact portions 1112, 1114, 1122, 1124 must be strong enough to withstand the connection process without degradation or breakage while still providing high levels of electrical conductivity to allow for an efficient electrical connection. While some materials, such as non-nanotwinned copper or non-alloy materials can achieve desired levels of electrical conductivity, the relatively low mechanical strength of this material means that the contact portions 1112, 1114, 1122, 1124 must be relatively large in order to ensure they can withstand the connection process. In some examples, however, where the contact portions 1112, 1114, 1122, 1124 include nanotwinned metallic alloy material, the contact portions 1112, 1114, 1122, 1124 can be designed to have much smaller dimensions that nevertheless still possess the requisite mechanical properties to ensure a desirable connection. Accordingly, the use of nanotwinned metallic alloy materials in the connectors 1110, 1120 can allow for the connectors to be significantly reduced in size as compared to connectors that include non-nanotwinned metals. Further details regarding electrical components including nanotwinned metallic alloy materials are described with respect to FIGS. 10A-10C.

FIG. 10A illustrates a connector receptacle 1250. The connector receptacle can include some or all of the features of any of the components described herein, such as including a nanotwinned metallic alloy material, and can be substantially similar to the connector receptacle 1050 described with respect to FIG. 8B. The connector receptacle 1250 can include a housing 1230 having a front guide 1210 forming a front opening 1212. In some examples, a connector insert can be inserted into the connector receptacle 1250 via the opening 1212 in the front guide 1210. A number of contacts 1220 can be located in slots or passages 1213 in the housing 1230. The connector receptacle 1250 can also include additional contact structures, such as side ground contacts that can be exposed through side openings in the housing 1230. The contacts 1220 and the side ground contacts can provide a retention force when a connector insert is inserted into this connector receptacle 1250. The housing 1230 can also include posts 1222. The posts 1222 can be electrically coupled to other components of an electronic device, for example, by placement in openings of a printed circuit board, device enclosure, or other appropriate substrate for mechanical stability.

Electrical signals and/or power can be conveyed from a connector insert to the contacts 1220 at high data and/or power rates. Also, a relatively large number of signals can be packed into a fairly small connector receptacle 1250. In some examples, in order provide high levels of signal integrity and quality, as well as highly efficient power transmission, the contacts 1220 can be formed from a material having high levels of electrical conductivity, such as a nanotwinned metallic alloy material. For example, the contacts 1220 can be formed from nanotwinned Cu-based alloy materials described herein. The resulting contacts 1220 can have a lower impedance or resistance but can also have desirable levels of mechanical properties that can allow the contacts 1220 to provide a strong beam spring force when engaging with a connector insert. Accordingly, because of the efficiencies provided by the high electrical conductivity of the contacts 1220 and the relatively high levels of mechanical strength, the contacts 1120 can be thinner, shorter, and/or smaller in any number of dimensions as compared to similar contacts formed from non-nanotwinned and/or non-alloyed materials, while providing similar or even improved levels of performance.

FIGS. 10B-10C are simplified cross-sectional views of the mating process of a connector insert 1252 and a connector receptacle 1250. FIG. 10B shows the connector insert 1252 and connector receptacle 1250 prior to insertion of the connector insert 1252 into the opening 1212 of the connector receptacle 1250 shown in FIG. 10A. FIG. 10C shows the connector insert 1252 fully inserted into the connector receptacle 1250 such that contact portion 1254 of the connector insert 1252 is in electrical contact with the contacts 1220 of the connector receptacle 1250. In some examples, the contact portion 1254 of the connector insert 1252 can include a nanotwinned metallic alloy material, such as nanotwinned metallic Cu-based alloys. The increased electrical conductivity provided by the nanotwinned metallic alloy material of the contacts 1220 and the contact portions 1254 can have a synergistic effect, providing high levels of efficiency in data and power that are transmitted from the connector insert 1252 to the connector receptacle 1250, and on to other components of the electronic device including the connector receptacle 1250.

As can also be seen in FIGS. 10B and 10C, the contacts 1220 of the connector receptacle 1250 can have a spring bias such that they are in an elevated position when connector insert 1252 is not inserted, and in a depressed or downward second position (shown in FIG. 10C) when the connector insert 1252 is inserted. This bias can aid in maintaining contact between contacts 1220 and contact portion 1254 throughout the life of connector receptacle 1250. In order to provide such a function, however, the materials of the contacts 1220 must have desired levels of mechanical strength and durability in addition to desired electrical properties. Accordingly, the nanotwinned metallic alloy material forming the contacts 1220 can provide such properties. Further details of a component of an electronic device including nanotwinned metallic alloy material are provided with respect to FIG. 11.

FIG. 11 is a perspective view of a schematic diagram of a camera module 1360. The camera module 1360 can include some or all of the features of any of the components described herein and can be substantially similar to the camera module 960 described with respect to FIG. 18B. In some examples, the camera module 1360 can include a lens barrel holder 1305, which can extend upward around the outer circumference of solid state lens 1310, thereby providing a physical barrier to guard the edges of the solid state lens 1310 and helping to minimize the likelihood of the solid state lens 1310 being damaged when the camera module 1360 makes contact with external objects.

In some examples, the lens barrel holder 1305, or other locations on the camera module 1360, can include multiple respective contact areas corresponding to multiple electrically conductive connections 1315. In some examples, the conductive connections 1315 can be located at least partially below the solid state lens 1310 and can make both physical and electrical contact with the solid state lens 1310. Similarly, multiple respective lower conductive connections 1325 can be attached to the conductive connections 1315 through respective conductive interconnects 1320.

In some examples, the electrically conductive connections 1315, lower conductive connections 1325, and/or conductive interconnects 1320 can include nanotwinned metallic alloy material, such as nanotwinned Cu-based alloys. In some examples, the electrically conductive connections 1315, lower conductive connections 1325, and/or conductive interconnects 1320 can be formed by a laser direct structuring (LDS) or other additive manufacturing process. In some examples, such as where formed by a LDS process, a laser can trace the desired locations (e.g., channels) of the interconnect electrical traces along the wall of lens barrel holder 1305 and a subsequent nanotwinned metallic material deposition step (e.g., electrodeposition or electroforming, as described herein) causes the nanotwinned metallic material to be deposited onto and adhere to the traced channels on the inner surface of the wall of lens barrel holder 1305 to a desired thickness.

In some examples, the electrically conductive connections 1315, lower conductive connections 1325, and/or conductive interconnects 1320 including nanotwinned metallic alloy materials can transmit various types of control signals, provide electrical power, and/or provide electrical grounding between the solid state lens 1310 and a substrate of the camera module 1360, or between other components of an electronic device including the camera module 1360, thereby enabling communication with one or more processor(s), other control modules, electrical power sources, and/or electrical ground connections. As described herein, the levels of mechanical strength and electrical conductivity provided by the nanotwinned metallic alloy material of the electrically conductive connections 1315, lower conductive connections 1325, and/or conductive interconnects 1320 can allow for rapid and efficient transmission of high power levels and/or large amounts of information to the camera module 1360. In some examples, the use of the electrically conductive connections 1315, lower conductive connections 1325, and/or conductive interconnects 1320 including nanotwinned metallic alloy materials can allow for the camera module 1360 to operate and capture images rapidly, reliably, and at high speeds.

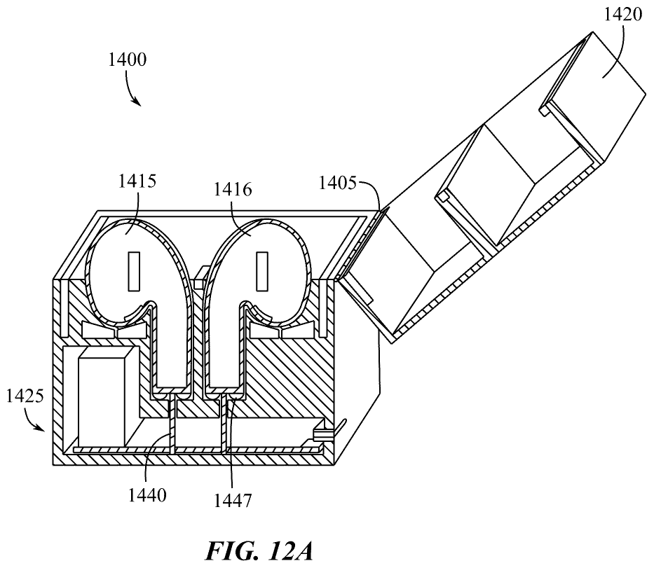

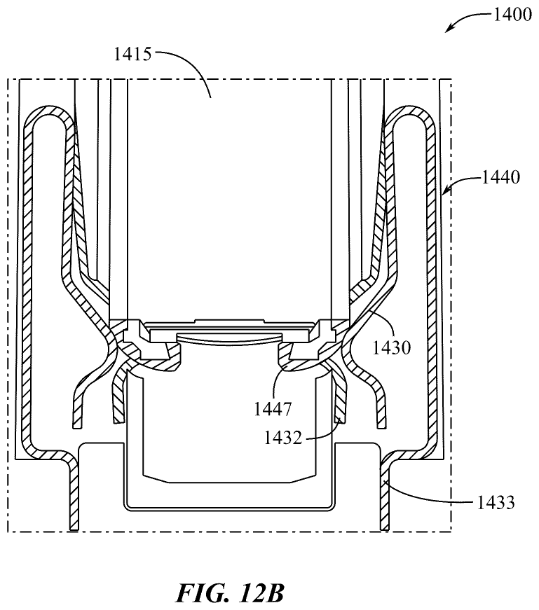

Any number or variety of electronic device components can include a nanotwinned metallic alloy material. The process for forming such a nanotwinned metallic alloy material, for example, forming nanotwinned metallic alloy material having a thickness greater than 50 microns, can include depositing the nanotwinned metallic alloy material onto a carrier to a desired thickness, as described herein. The nanotwinned metallic alloy material can be formed into a desired shape during deposition and/or can be subjected to manufacturing processes or treatments to achieve a desired shape, for example, to form all or a portion of an electronic component. Various example components including nanotwinned metallic alloy materials are described below with reference to FIGS. 12A-12B.

FIG. 12A depicts a simplified plan view of a case 1400 for a pair of wireless earbuds 1415, 1416. The case 1400 and wireless earbuds 1415, 1416 can include some or all of the features of the components described herein. As shown in FIG. 12A, the case 1400 can include a housing 1425, also called a body, having one or more cavities and configured to receive a pair of earbuds 1415, 1416. In some examples, the cavities can be positioned adjacent to each other on opposite sides of a center plane of case 1400. Each cavity can be sized and shaped to match that of its respective earbud 1415, 1416.

In some examples, the case 1400 can further include a lid 1420 attached to the housing 1425. The lid 1420 can be operable between a closed position where lid 1420 is aligned over one or more cavities of the housing 1425 fully enclosing pair of earbuds 1415, 1416 within the housing 1425, and an open position, as shown, where the lid 1420 is displaced from the housing 1425 and cavities such that a user can remove the earbuds 1415, 1416 from the cavities or replace the earbuds within the cavities. The lid 1420 can be pivotably attached to the housing 1425, for example, by a hinge component 1405 and can include a magnetic or mechanical system (not shown) that provides the lid 1420 with a bi-stable operation. In some examples, the case 1400 can also include a charging system configured to charge pair of earbuds 1415, 1416. In some examples, the case 1400 can thus include a battery or other electrical power source (not shown) and can include one or more electrical contacts 1440 that can be electrically coupled to the power source. In some examples, when the earbuds 1415, 1416 are inserted into the cavities of the housing 1425, electrical contacts 1447 on each earbud can form an electrical connection with the contacts 1440 to provide electrical power to the earbuds 1415, 1416, for example, to charge a battery or other power source contained therein.

FIG. 12B illustrates a close-up cross-sectional view of the case 1400 including an earbud 1415 disposed in a cavity thereof. The case 1400 can include a case connector or contact 1440 that can be incorporated into the earbud case 1400 and an electrical earbud connector or contact 1447 disposed at the end of a stem portion of an earbud 1415. Some or all of the components of a case connector 1440 can make electrical contact with electrical earbud connector 1447 to provide electrical power to the earbud 1415.

The combination of arcuate surfaces on the earbud contact 1447 and earbud case contact 1440 enable a contact wiping motion each time the earbuds 1415, 1416 are inserted within and drawn out of the case 1400, creating a reliable interconnect. In FIG. 12B, a portion 1430 of the case contact 1440 is illustrated in a deflected state that shows its approximate position when earbud 1415 is fully inserted into its receiving cavity such that the earbud contact 1447 is engaged with the earbud case connector or contact 1440.

During a mating event, as earbud 1415 is inserted deeper into the earbud receiving cavity, the earbud case contact 1440 can come into physical and/or electrical contact with the earbud contacts 1447 and deflect outward. The exterior contacting surfaces of the earbud contacts 1447 and earbud case contacts 1440 rub against each other during both the mating event and during a de-mating event when the earbud 1415 is withdrawn from the earbud receiving cavity. In some examples, the earbud case contact 1440 can also include a base contact portion 1432 that can contact a second location of the earbud contact 1447 to provide a reliable connection. Further, the earbud case contact 1440 can include a connection 1433 to connect the portions 1432, 1430 to a power source of the case 1400.

In some examples, some or all of the earbud case contact 1440, such as portions 1430, 1432, 1433, and the earbud contact 1447 can be formed from or include nanotwinned metallic alloy materials, such as nanotwinned metallic Cu-based alloy materials described herein. In addition to the electrical efficiencies provided by the high electrical conductivity of the nanotwinned metallic alloy material, it can also be advantageous to form the contacts 1440, 1447 from nanotwinned metallic alloy material because of the high levels of physical wear that the wiping motion caused by insertion and removal of the earbuds 1415, 1416 can cause. The high hardness and strength of a nanotwinned metallic alloy material, as described herein, can ensure that these contacts do not degrade or become undesirably worn over time, thereby ensuring electrical contact throughout the life of the case 1400.

Additionally, in some examples, the earbuds 1415, 1416 can include a magnet or magnetic component that can be attracted to at least one housing magnetic component disposed within case 1400. The attraction can be strong enough to magnetically secure the earbuds 1415, 1416 into their respective cavities. In order for this magnetic retention system to operate as desired, it can be advantageous for the contacts 1440, 1447 and other components of the case 1400 to be formed from non-ferromagnetic materials. Nanotwinned metallic Cu-based alloys, being non-ferromagnetic, can thus provide the advantages described above without interfering with the magnetic retention system of the case 1400.

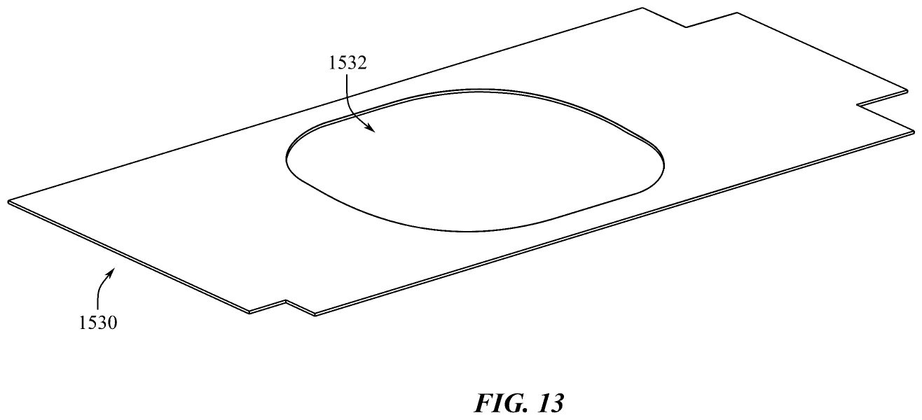

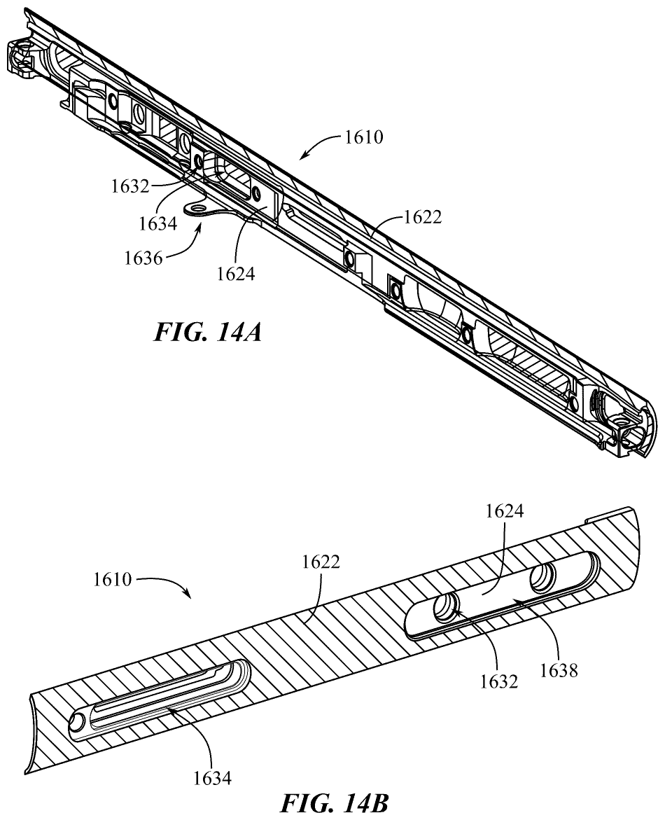

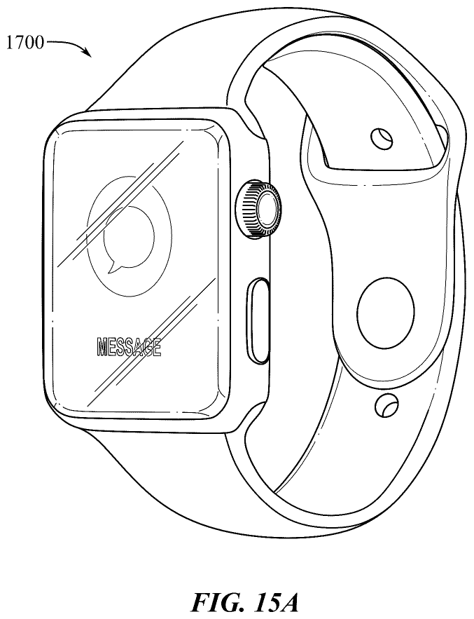

Any number or variety of electronic device components can include a nanotwinned metallic alloy material. The process for forming such a nanotwinned metallic alloy material, for example, forming nanotwinned metallic alloy material having a thickness greater than 50 microns, can include depositing the nanotwinned metallic alloy material onto a carrier to a desired thickness, as described herein. The nanotwinned metallic alloy material can be formed into a desired shape during deposition and/or can be subjected to manufacturing processes or treatments to achieve a desired shape, for example, to form all or a portion of an electronic component. Various example components including nanotwinned metallic alloy materials are described below with reference to FIGS. 13-14B.

FIG. 13 illustrates a perspective view of a support component 1530 that can be substantially similar to and can include some or all of the features of the support component 1030 described herein. The support component 1530 can have a substantially planar or flat shape or profile. That is, the support component 1530 can have a desired shape extending in any amount of desired distances and configurations in two dimensions, while having a substantially uniform height or thickness in a third dimension perpendicular to the first two dimensions. Thus, in some examples, the support component 1530 can include a plate, a sheet, or another substantially planar structure having any desired peripheral profile. The support component 1530 can have a substantially planar shape or profile but can nevertheless include one or more non-planar portions or features, such as protrusions, bumps, flanges, combinations thereof, or any other desired features. Further, in some examples, the support component 1530 can define a first surface, also referred to as a top surface (shown), and a second surface opposite the first surface, also referred to as the bottom surface (not shown).

In some examples, the support component 1530 can define one or more apertures or through-holes, such as an aperture 1532 disposed at any desired location on the support component 1530. In some examples, the aperture 1532 can allow components or electromagnetic radiation to pass through the support component 1530 at the location of the aperture 1532, as described herein. In some examples, the support component 1530 can include or define one or more attachment features or locations. For example, all or a portion of the periphery of the support component 1530 can be shaped to provide attachment features or locations for one or more other components of an electronic device, as described herein. In some examples, components can be attached to the support component 1530 at any location, such as at a location along the periphery of the support component 1530, or to one or more surfaces thereof, by welding, joining, bonding, adhering, or any other desired form or combination of forms of attachment.

In some examples, the support component 1530 can be formed from, or can include, a nanotwinned metallic alloy material, such as nanotwinned Cu-based alloys described herein. In some examples, the support component 1530 can be a monolithic or unitary piece of nanotwinned metallic alloy material. It can be desirable for a structural component that can support one or more components in an electronic device and/or provide stiffness and rigidity to the device, such as the support component 1530, to also have desired thermal conduction properties, thereby allowing the support component 1530 to serve as a heat sink and/or thermal spreader for the operational components that are thermally coupled to the support component. The mechanical and thermal conduction properties of the nanotwinned metallic alloy materials described herein can thus allow for the support component 1530 to perform these functions without the need for additional structural materials or components.

In some examples, the support component 1530 can have a thickness between about 50 microns and about 1000 microns, between about 100 microns and about 500 microns, or between about 150 microns and about 250 microns. In some examples, the support component 1530 can have a thickness of about 200 microns or less. Additional details of structural components of an electronic device as described with respect to FIGS. 14A-14B.

FIG. 14A shows a sidewall component 1610 that can be similar to or include the features of the composite sidewall components 1004, 1006, 1008, 1010 described with respect to FIG. 8B. The sidewall component 1610 can include an outer or exterior portion 1622 that is joined to an inner or interior portion 1624. In the present example, the exterior portion 1622 can at least partially define an exterior surface of a housing or enclosure of an electronic device. The interior portion 1624 can at least partially define a surface of an internal volume of the electronic device. As can be seen in FIG. 14A, the composite component 1610 can include a number of features 1632, 1634, 1636, that can, for example, act as attachment features for other components of an electronic device, to provide a mechanical, thermal, and/or electrical connection therebetween.

In some examples, the interior portion 1624 of the component 1610 can be selected such that it has a set of material properties that can allow for mechanical support of components attached thereto, while also providing high levels of thermal and/or electrical conductivity. Thus, in some examples, the interior portion 1624 can be formed from or include a nanotwinned metallic alloy material, such as nanotwinned metallic Cu-based alloys described herein. In some examples, the interior portion 1624 including nanotwinned metallic alloy material can function as a heat sink or other form of thermal management component for any components attached thereto. Additionally, the high levels of mechanical strength provided by the nanotwinned metallic alloy material can allow for components to be securely attached to features 1632, 1634, 1636 and can allow for the component 1610 to also provide mechanical support. Further, the material of the exterior portion can be selected to have a material property or set of material properties, independent of the material properties of the interior portion, which allow the exterior portion 1622 to have, for example, high levels of hardness and corrosion resistance and/or a desired cosmetic appearance.

In some examples, the features formed in one or both of exterior portion 1622 and interior portion 1624, such as features 1632, 1634, 1636, can have a major dimension from about a micron up to about a millimeter, or several millimeters or more. In some cases, a feature, such as feature 1636 can have a major dimension from about 100 microns to about 1 millimeter. Further, in some examples, a feature, such as feature 1636, can have minor dimensions from about 100 microns to about 1 millimeter.

Further, as can be seen in FIG. 14A, the exterior portion 1622 can have a substantially curved shape or profile that can correspond to an exterior profile of the electronic device. The exterior portion 1622 can have any shape or profile, as desired. In some examples where the exterior portion 1622 has a substantially curved shape or profile, the interior portion 1624 can be positioned entirely behind or within a curve defining the curved profile of the exterior portion 1622.

FIG. 14B shows another perspective view of the component 1610. As can be seen in FIG. 14B, one or more areas, such as area 1638, of the exterior portion 1622, can be removed so that at least some of the nanotwinned metallic alloy material forming the interior portion 1624 can be exposed. The exposed surface of the interior portion 1622 can be subjected to a treatment or other processing in order to, for example, protect the exposed surface of the interior portion 1622. Although described as including two portions 1622, 1624, including different materials, in some examples, the component 1610 can be a unitary or continuous component including a nanotwinned metallic alloy material. In some examples, the advantageous mechanical properties of nanotwinned metallic alloy materials can allow for the component 1610 to have desired levels of hardness and durability to function as an exterior surface of an electronic device and to withstand everyday wear.

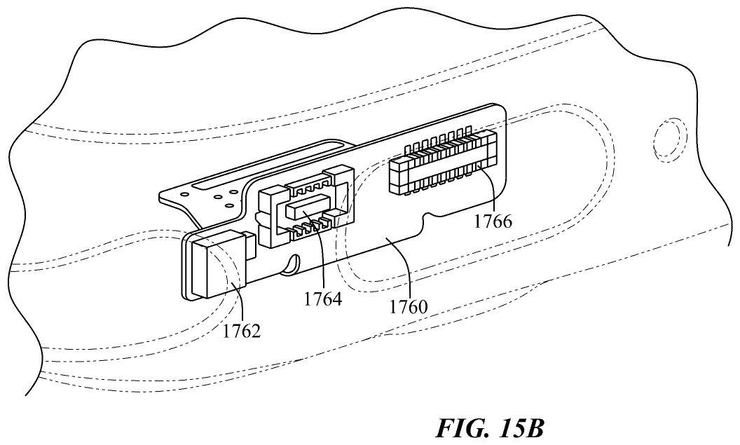

Any number or variety of electronic device components can include a nanotwinned metallic alloy material. The process for forming such a nanotwinned metallic alloy material, for example, forming nanotwinned metallic alloy material having a thickness greater than 20 microns, can include depositing the nanotwinned metallic alloy material onto a carrier to a desired thickness, as described herein. The nanotwinned metallic alloy material can be formed into a desired shape during deposition and/or can be subjected to manufacturing processes or treatments to achieve a desired shape, for example, to form all or a portion of an electronic component. Various example components including nanotwinned metallic alloy materials are described below with reference to FIGS. 15A-15B.

FIG. 15A shows an example of an electronic device 1700. The electronic device shown in FIG. 15A is a watch, such as a smartwatch. The smartwatch 1700 of FIG. 15A is merely one representative example of a device that can be used in conjunction with the components and methods disclosed herein. The electronic device 1700 can correspond to any form of wearable electronic device, portable media player, media storage device, portable digital assistant (“PDA”), tablet computer, computer, mobile communication device, GPS unit, remote control device, or other device. The electronic device 1700 can be referred to as an electronic device, or a consumer device. Further details of the watch 1700 are provided below with reference to FIG. 15B.

FIG. 15B illustrates a view of a support component 1760 and its position in the internal volume at least partially defined by the housing of the smartwatch 1700 of FIG. 15A. In some examples, the support component 1760 can take the form of a bracket or a brace. The support component 1760 can be affixed to other components of the device 1700 by features such as studs, posts, screws, or any other feature for attachment or securement. In some examples, one or more electronic components or sensors can also be affixed to the support component 1760. For example, the components 1762, 1764, and 1766 can all be affixed to a surface of the support component 1760, as shown, by any desired technique or feature. In some examples, these electronic components 1762, 1764, 1766 can include processors, memory components, sensors, antennas, sound or light emitting components, batteries, or any other desired electronic components. In some examples, the support component 1760 can include a nanotwinned metallic alloy material, such as nanotwinned Cu-based alloys described herein. The material properties of the nanotwinned metallic alloy material forming the support component 1760 can allow the support component 1760 to provide desired levels of mechanical support to the components 1762, 1764, 1766, while also managing and distributing the thermal loads generated by the components 1762, 1764, 1766, for example, by distributing or directing heat generated by the components 1762, 1764, 1766 to a desired location or locations, so as to allow for improved levels of device performance.

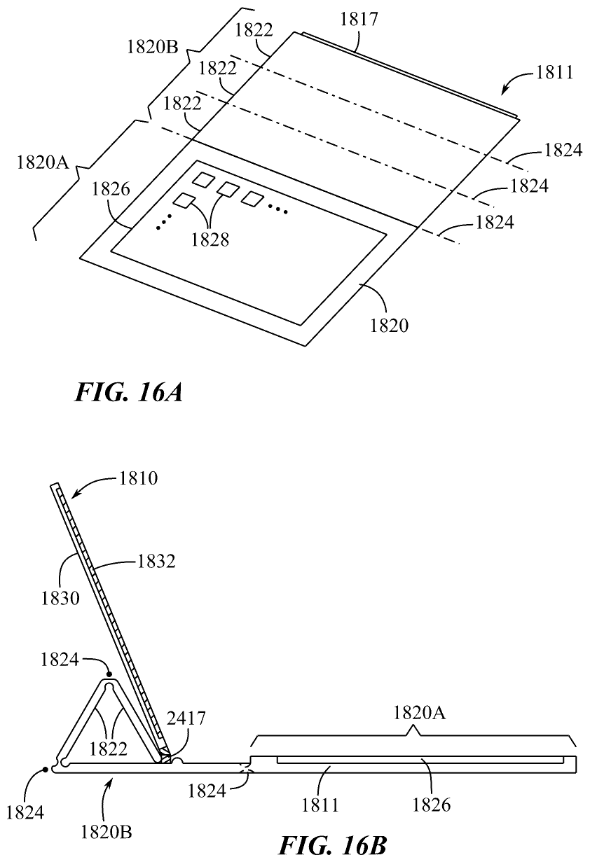

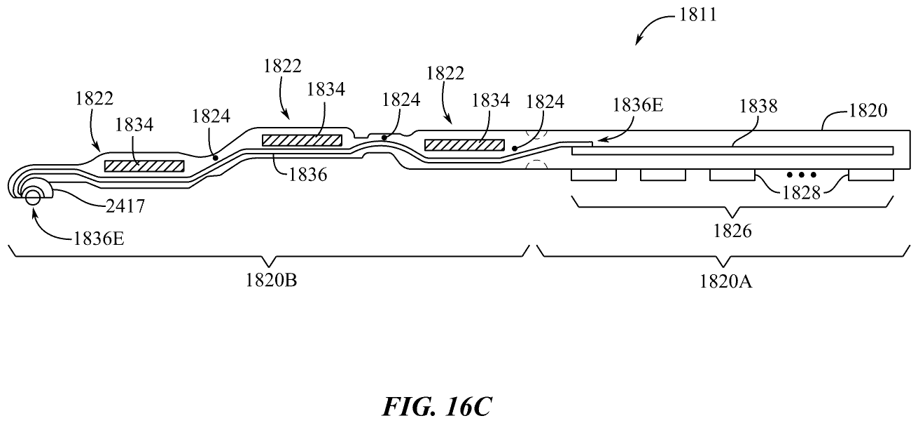

Any number or variety of electronic device components can include a nanotwinned metallic alloy material. The process for forming such a nanotwinned metallic alloy material, for example, forming nanotwinned metallic alloy material having a thickness greater than 50 microns, can include depositing the nanotwinned metallic alloy material onto a carrier to a desired thickness, as described herein. The nanotwinned metallic alloy material can be formed into a desired shape during deposition and/or can be subjected to manufacturing processes or treatments to achieve a desired shape, for example, to form all or a portion of an electronic component. Various example components including nanotwinned metallic alloy materials are described below with reference to FIGS. 16A-16C.

FIG. 16A shows a perspective view of an electronic device accessory component 1811. An electronic device, such as the device 1810 illustrated in FIG. 16B can be coupled to the accessory component 1811 for use therewith. In some examples, the device 1810 can be a tablet computer. The tablet computer 1810 of FIG. 16B is merely one representative example of a device that can be used in conjunction with the systems and methods described herein, and that can include one or more components and/or materials described herein. Electronic device 1810 can correspond to any form of a wearable electronic device, a portable media player, a media storage device, a portable digital assistant (“PDA”), a tablet computer, a computer, a mobile communication device, a GPS unit, a remote-control device, or any other electronic device. The electronic device 1810 can be referred to as an electronic device, or a consumer device.

In some examples, the device 1810 and component 1811 can be used together. For example, the input resource of the input-output component in component 1811 can be used to gather input from a user. This user input can then be conveyed to device 1810 over signal paths for use in controlling the operation of device 1810. As shown in FIG. 16A, component 1811 can be a flexible cover that can be used to protect an electronic device such as a tablet computer or other computing device. In some examples, the component 1811 can include body 1820. The body 1820 can have surfaces formed from plastic, fabric, microfiber embedded in a polymer layer, or other suitable materials. For example, one side of the body 1820 (e.g., the exterior of body 1820 when component 1811 is closed around device 1810) can be formed from a sheet of polymer and the other side of body 1820 (e.g., the inner surface of body 1820) can be formed from a microfiber layer.

The component 1811 can include input-output components such as keyboard 1826, including keys 1828, a touch pad (trackpad) that gathers touch and/or force input, and/or other input-output components. In some examples, the keyboard 1826 can be mounted in lower portion 1820A of the component 1811. In some examples, the upper portion 1820B of the component 1811 can contain foldable sections (horizontal strips) such as sections 1822. In some examples, the sections 1822 can bend about one or more bend axes, such as bend axes 1824. In some examples, the upper portion 1820B can have a connector such as connector 1817 to provide an electrical connection to the device 1810. In some examples, the connector 1817 can mate with a connector that is associated with device 1810. In some examples, the connector 1817 can contain electrical contacts for coupling to corresponding connector contacts in the device 1810. These contacts can be electrically coupled to electrical components in lower portion 1820A such as keyboard 1826 (e.g., one or more integrated circuits for gathering keystroke information during the operation of keys 1828 in keyboard 1826).

To accommodate bending of the housing body 1820 about bend axes 1824, the housing 1820 can be provided with flexible hinge portions along the boundaries between sections 1822 (i.e., along axes 1824). A signal path for coupling connector 1817 to circuitry in keyboard 1826 can run across axes 1824 (i.e., the signal path can cross each of axes 1824 at a right angle so as to extend between connector 1817 and keyboard 1826). In some examples, because the signal path overlaps bend axes 1824, the signal path is preferably formed from a flexible signal path structure. With one suitable arrangement, the flexible signal path structure can be formed from a flexible fabric signal path structure having metal traces on a flexible fabric substrate or having conductive strands of material that are formed as part of the flexible fabric substrate. In some examples, and as described herein, the signal path can include nanotwinned metallic alloy materials.

A cross-sectional side view of component 1811 and an associated electronic device such as device 1810 is shown in FIG. 16B. As shown, the component 1811 can be folded along bend axes 1824 to form a stand for device 1810. In some examples, the device 1810 can have a housing 1830 and a display 1832 that is mounted in housing 1830. The component 1811 can support device 1810 in a position that allows display 1832 to be easily viewed by a user while the user is typing on keyboard 1826. When device 1810 is supported by the component 1811, a connector of the device 1810 can mate with connector 1817 of component 1811. In some examples, one or both of the connector of the device 1810 and the connector 1817 can include nanotwinned metallic alloy materials. In some examples, the component 1811 can bend along axis such as axes 1824 and/or other bend axes that span the width of the component 1811.

FIG. 16C shows an illustrative cross-sectional side view of the component 1811. In some examples, the component 1811 can include one or more stiffeners, such as fiberglass stiffeners 1834 (e.g., stiff rectangular panels of material). In some examples, a flexible fabric signal path structure 1836 can include ends 1836E that are coupled between the connector 1817 and a printed circuit 1838 or other electronic component of the component 1811. In some examples, the printed circuit 1838 can be located in lower body portion 1820A of body 1820 and can contain circuitry for controlling the operation of keyboard 1826 (e.g., key switches, integrated circuits, signal traces, etc.). In some examples, the flexible fabric signal path structure 1836 can span locally thinned portions of body 1820 that serve as hinges along bend axis 1824.

In some examples, the fabric structure 1836 can include nanotwinned metallic alloy materials and can define one or more signal paths to transmit electrical power and signals. In some examples, the signal paths can be formed from a series of parallel nanotwinned metallic traces that run along the length of fabric structure 1836 (i.e., between connector 1817 and printed circuit 1838) and that serve as a signal bus. In some examples, nanotwinned metallic alloy material can be electroplated, electrodeposited, electroformed, or otherwise manufactured, such as through an LDS process, as described herein to form the traces. Advantageously, the high electrical conductivity and mechanical strength of the nanotwinned metallic alloy material forming the traces can allow for very thin sections of metallic material that can bend and deform with the component 1811, but that can still efficiently transmit power and signals at a desired rate or amount.

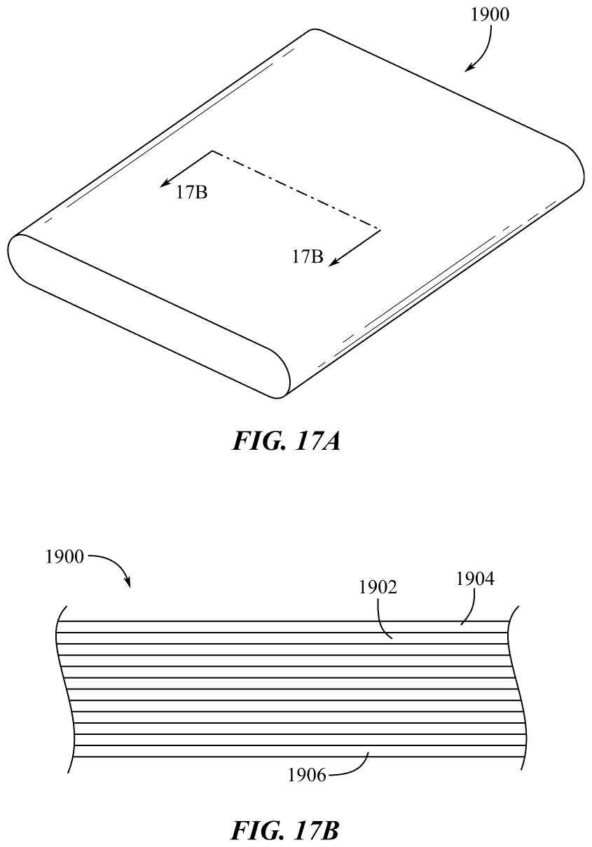

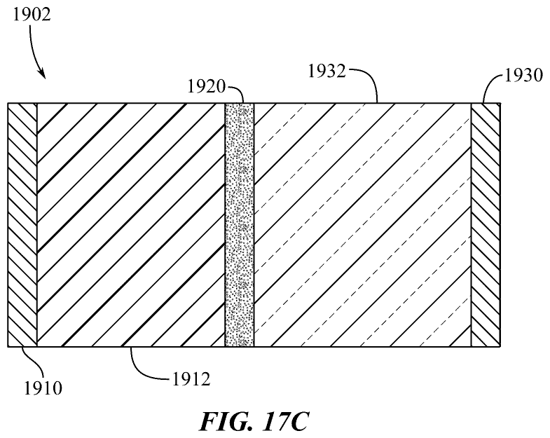

Any number or variety of electronic device components can include a nanotwinned metallic alloy material. The process for forming such a nanotwinned metallic alloy material, for example, forming nanotwinned metallic alloy material having a thickness greater than 50 microns, can include depositing the nanotwinned metallic alloy material onto a carrier to a desired thickness, as described herein. The nanotwinned metallic alloy material can be formed into a desired shape during deposition and/or can be subjected to manufacturing processes or treatments to achieve a desired shape, for example, to form all or a portion of an electronic component. Various example components including nanotwinned metallic alloy materials are described below with reference to FIGS. 17A-17C.

FIG. 17A illustrates a battery or battery pack 1900. In some examples, the battery 1900 can be a rechargeable battery. In some examples, and as shown in FIG. 17B, the battery 1900 can include a number of electrochemical cells 1902, 1904, 1906. The cells 1902, 1904, 1906 can be coupled in series or parallel and can correspond to rechargeable (e.g., secondary) cells such as nickel-cadmium (Ni—Cd) cells, nickel-metal-hydride (Ni-MH) cells, lithium-ion cells, lithium-polymer, and/or any other form of electrochemical cell now known or discovered in the future. For example, one or more cells 1902, 1904, 1906 can correspond to lithium-ion cells, each of which includes multiple layers (e.g., a cathode with a current collector, a separator, and an anode with a current collector). The structure of a single electrochemical cell 1902 is discussed below with reference to FIG. 17C.

In some examples, an electrochemical cell 1902 can include an anode active material or anode layer 1912 that is secured or bonded to a current collector 1910. The cell 1902 can also include a cathode active material or cathode layer 1932 that is secured or bonded to a current collector 1930. The anode material 1912 and the cathode material 1932 can be separated from one another by a porous separator layer 1920. In some examples, the separator 1920 can include a polymer and can include a conducting electrolyte. In some examples, the cathode material 1932 can include a lithium compound and the current collector 1930 can include a conductive film or foil, such as a metallic foil, for example, an aluminum foil. In some examples, however, the current collector 1930 can include a nanotwinned metallic alloy foil or film, such as a nanotwinned Cu-based alloy foil. In some examples, the cathode material 1932 can be deposited or coated onto the current collector 1930. In some examples, the anode material 1912 can include carbon, such as graphite. The current collector 1910 can include a conductive film or foil, such as a copper foil. In some examples, the current collector 1910 can include a nanotwinned metallic alloy foil or film, such as a nanotwinned Cu-based alloy foil. In some examples, the anode material 1912 can be deposited, coated, or formed onto the previously formed current collector 1910 including nanotwinned metallic alloy material.

Although the electrochemical cells of the battery 1900 are illustrated as having a flat or laminar layer structure, substantially any shape and configuration of cells can be used. For example, the battery 1900 can include cells including layers such as a nanotwinned metallic alloy current collector that can be wound around a mandrel to form a spirally wound structure. Additionally, in some examples, the cells can vary in size and can be stacked in a configuration to achieve any shape or form of battery 1900 as desired.

Any of the materials, structure, properties, features, or aspects of the components described herein can be combined or included in any varied combination. For example, the design and shape of any component including a nanotwinned metallic alloy material is not limited in any way and can be all or a part of any component or components of an electronic device. While certain exemplary nanotwinned metallic alloy materials and processes for their formation and manufacture have been discussed, these materials can be used in any desired manner and can include any of the described material properties.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An alloy material, comprising:
An electrodeposited first metal and a second metal, the alloy material comprising crystal grains, wherein the second metal comprises at least one of cobalt (Co), iron (Fe), or Palladium (Pd);
wherein at least 75% of the crystal grains comprise nanotwin boundaries.

2. The alloy material of claim 1, wherein the crystal grains have an average grain size between about 190 and 940 nanometers (nm).

3. The alloy material of claim 1, wherein the first metal comprises copper.

4. The alloy material of claim 1, wherein the alloy material has a thickness of less than 50 microns.

5. The alloy material of claim 1, wherein the alloy material exhibits a tensile strength greater than about 750 MPa.

6. The alloy material of claim 1, wherein the crystal grains have an average spacing between nanotwin boundaries of less than 120 nanometers (nm).

7. The alloy material of claim 1, wherein at least 85% of the crystal grains comprise nanotwin boundaries.

8. The alloy material of claim 1, wherein the alloy material exhibits a tensile elongation greater than 2.5%.

9. An electronic device, comprising:
a conductive component comprising an alloy material including crystal grains, the alloy material comprising a copper (Cu) alloy having a thickness of greater than 20 microns; and
at least 70% of the crystal grains comprising nanotwin boundaries.

10. The electronic device of claim 9, wherein the copper alloy comprises less than about 40 ppm cobalt (Co), iron (Fe), or Palladium (Pd).

11. The electronic device of claim 9, wherein the conductive component is an electrically conductive component.

12. The electronic device of claim 11, wherein the electrically conductive component comprises a charging receptacle.

13. The electronic device of claim 11, wherein the electrically conductive component comprises an electrical connector between two electronic components.

14. The electronic device of claim 11, wherein the electrically conductive component comprises a battery.

15. The electronic device of claim 9, wherein the conductive component is a thermally conductive component.

16. The electronic device of claim 15, wherein the thermally conductive component comprises a support plate.

17. A method of forming a component, comprising:
electroplating a metallic material comprising crystal grains, the crystal grains comprising nanotwin boundaries;
wherein the metallic material comprises a copper (Cu) alloy comprising less than about 40 ppm cobalt (Co), iron (Fe), or Palladium (Pd).

18. The method of claim 17, wherein electroplating a metallic material comprises at least partially immersing the carrier in an electrolyte solution comprising cations of the metallic material and a suppressor agent.

19. The method of claim 18, wherein the electrolyte solution exhibits a temperature between about 17° C. and about 25° C.

20. The method of claim 17, wherein depositing the metallic material comprises co-electroplating with ions of copper (Cu) and ions selected from the group consisting of cobalt (Co), iron (Fe), or Palladium (Pd).
